(19) United States
(12) Patent Application Publication
(10) Pub. No.: US 2021/0153533 A1
(43) Pub. Date: May 27, 2021

(54) SWEETENER COMPOSITION

(71) Applicant: Nutrition Science Design Pte. Ltd, Singapore (SG)

(72) Inventors: David KANNAR, Singapore (SG); Meng Wai WOO, Clayton, Victoria (AU); Yongmei SUN, Clayton, Victoria (AU)

(21) Appl. No.: 17/047,554

(22) PCT Filed: Apr. 17, 2019
(86) PCT No.: PCT/SG2019/050219

§ 371 Date: Oct. 14, 2020

(30) Foreign Application Priority Data
Apr. 17, 2018 (SG) 10201803202W

(51) Int. Cl. A23L 27/30; A23L 27/12; A23L 33/22; A23L 2/60

(52) U.S. Cl. CPC A23L 27/34; A23L 27/36; A23V 2002/00; A23L 33/22; A23L 2/60; A23L 27/12

(57) ABSTRACT

The present invention provides a sweetener composition comprising (i) sucrose, (ii) one or more high intensity sweeteners and (iii) one or more masking agents. The taste masking agent may be a caramel; a low GI crystalline sugar comprising about 0 to 0.5 g/100 g reducing sugars and about 20 mg CE/100 g to about 45 mg CE/100 g polyphenols and the sugar particles have a glucose based glycaemic index of less than 55; and/or an amorphous sugar comprising sucrose, at least about 20 mg CE polyphenols/100 g carbohydrate and a low GI drying agent.

### FIELD OF THE INVENTION

The present invention relates to food and beverage sweeteners, in particular low calorie and/or low glycaemic index (GI) or low glycaemic load (GL) sweetener compositions, processes for the preparation of said sweeteners and the use of sweeteners in the preparation of food and beverages. It is preferred if the sweetener has a desirable flavour profile despite the use of high intensity sweeteners.

### BACKGROUND OF THE INVENTION

There is concern that refined white sugar is causal in the development of diabetes and obesity. This concern has created demand for products that retain their sweetness but have lower sugar content, in particular lower quantities of refined sucrose. It is especially desirable if the product is likely to provide health benefits or minimise the health risks.

Cane and beet sugars are mostly sucrose. The refining process used to prepare refined white cane sugar removes most vitamins, minerals and phytochemical compounds from the sugar leaving a “hollow nutrient”, that is, a food without significant nutritional value. Retention of vitamins, minerals and phytochemicals in sugar has been demonstrated to improve health and lower glycaemic index (GI) in some circumstances (see Jaffè, W. R., Sugar Tech (2012) 14:87-94). This is useful because it is thought that individuals who are susceptible to type II diabetes and coronary heart disease should follow a low GI diet.

Glycaemic response (GR) refers to the changes in blood glucose after consuming a carbohydrate-containing food. The glycaemic index is a measure of GR. It is a system for classifying carbohydrate-containing foods according to how fast they raise blood-glucose levels inside the body. A higher GI means a food increases blood-glucose levels faster. The GI scale is from 1 to 100. The most commonly used version of the scale is based on glucose. 100 on the glucose GI scale is the increase in blood-glucose levels caused by consuming 50 grams of glucose. High GI products have a GI of 70 or more. Medium GI products have a GI of 55 to 69. Low GI products have a GI of 54 or less. High GI foods trigger strong insulin responses. Frequently repeated strong insulin responses are thought to, over time, result in an increased risk of diabetes. Low GI foods do not trigger an insulin response. These are foods that cause slow rises in blood-sugar.

Low GI crystalline sugars have been produced but there is still a need for low GI and low GL sugar compositions that are low calorie. It is also useful if the sugar can be produced at lower cost and/or with low hygroscopicity so that it has a suitable shelf life and/or can be prepared in industrial quantities.

Artificial sweeteners, such as, saccharin, acesulfame, aspartame, neotame, and sucralose have been developed. However, the use of traditional artificial sweeteners has been directly correlated with increased risks of type II diabetes as well as the acceleration of obesity and inhibition of fat break down. Artificial sweeteners may also change gut microflora and products formulated with these products may need to contain laxative warnings.

A natural low calorie sweetener, stevia, has also been developed and approved for use in many countries. Stevia is a high intensity sweetener meaning that one gram is much sweeter than one gram of sugar. Stevia has been used, in combination with sucrose, in several commercial products. However, consumers consider stevia to have an undesirable metallic aftertaste.

Monk fruit extract and blackberry leaf extract are alternative natural high intensity sweeteners but, like stevia, they are expensive and consumers commonly complain that they have a metallic aftertaste. The aftertaste, as with stevia, is thought to result from overstimulation of taste receptors, which is common for high intensity sweeteners. Some artificial sweeteners are also high intensity sweeteners and have a metallic aftertaste.

Attempts have been made to reduce or mask the metallic taste by adding up to 4% salt, using various natural flavours and using mushroom enzymes. However, there is still a need for a more natural, less expensive and/or healthier taste masking strategy for high intensity sweeteners. These improvements could increase the use of high intensity sweeteners in the preparation of other foods, such as, chocolate, beverages, cereals, confectionary, bakery goods and other retail foods containing sugar.

There is a need to improve the flavour profile of sweeteners containing high intensity sweeteners, for example, reducing the undesirable metallic aftertaste of high intensity sweeteners.

There is also a need for low calorie sweeteners that are also low GI and/or low GL.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect, the present invention provides a sweetener composition comprising (i) sucrose, (ii) one or more high intensity sweeteners and (iii) one or more caramel masking agents. The inclusion of the caramel masking agent masks (ie reduces the perception of) the undesirable aspects of the taste of the high intensity sweetener.

In another aspect, the present invention provides a sweetener composition comprising

(i) a sugar including sugar cane sourced polyphenols and caramels; and
(iii) one or more high intensity sweeteners.

The sugar including sugar cane sourced polyphenols and caramels is optionally a low glycaemic sugar and/or an amorphous sugar as described below.

Alternatively, the present invention provides a sweetener composition comprising (i) a low GI crystalline sugar as described below and/or (ii) an amorphous sugar as described below; and (iii) one or more high intensity sweeteners. In this embodiment of the invention, the one or more taste masking agents are within the low GI crystalline sugar and/or the amorphous sugar ie the sugar as a whole functions to mask (ie reduce the perception of) the undesirable metallic after taste of the high intensity sweetener.

The taste masking benefit can be used to improve the taste profile of the sweetener composition compared to known high intensity sweeteners alone and/or their blends with traditional sugar and/or to increase the amount of high intensity sweetener that can be used in a palatable food or beverage, thereby allowing for further calorie reduction.

Caramels are prepared from sucrose when heated but are removed from refined white sugar. Optionally, the caramels in the sweetener composition are derived from sugar cane and/or beet sugar. Caramels are not inherent in raw sugar cane or sugar beet but are prepared during the processing of those plants as the sugar contained in them is heated during production. Sugar that is prepared from sugar cane or sugar beet generally includes caramels unless those caramels are removed by washing.

Consequently, products derived from sugar cane or sugar beet such as sugar cane juice, massecuite and molasses generally include caramels.

Optionally, the composition comprises 80-99.5% w/w or 90-99.5% w/w sucrose, 0.5 to 6% high intensity sweetener and 0.5 to 5% w/w caramel masking agent. Optionally, the composition is 0.5 to 1.5% w/w high intensity sweetener. Alternatively, the composition comprises 0.5 to 15% w/w (or 0.5 to 10% w/w) high intensity sweetener.

The composition may additionally include about 0 to 0.5 g/100 g reducing sugars and/or about 20 mg CE/100 g to about 45 mg CE/100 g polyphenols (or about 16 mg GAE/100 g to about 37 mg GAE/100 g polyphenols). Alternatively, composition may additionally include about 46 mg CE/100 g to about 100 mg CE/100 g or about 37 mg GAE/100 g to about 80 mg GAE/100 g polyphenols and 0 to 1.5% w/w reducing sugars, wherein the sugar is not more than 0.5% w/w fructose and not more than 1% w/w glucose. Alternatively, the composition may include about 20 mg CE/100 g to about 100 mg CE/100 g polyphenols (about 16 mg GAE/100 g to about 80 mg GAE/100 g polyphenols).

Optionally, the amount of sucrose in the sweetener composition is 20 to 60% w/w less than the amount needed for equivalent sweetening by sucrose alone.

Optionally, the one or more high intensity sweetener is a natural high intensity sweetener. Optionally, the composition comprises the high intensity sweetener monk fruit extract, blackberry leaf extract, stevia or a combination thereof.

Optionally, the one or more high intensity sweeteners have a relative sweetness factor of 50 or more, 100 or more, or 200 or more.

In some embodiments the sweetener composition further comprises an artificial sweetener, for example, xylitol (relative sweetness factor of 1) or erythritol (relative sweetness factor of 0.7). These artificial sweeteners are not high intensity sweeteners.

Optionally, the sweetener composition is low GI and/or low GL.

### Low GI Crystalline Sugars

In some embodiments, the high intensity sweeteners are combined with a low GI crystalline sugar.

International patent application no PCT/AU2017/050782 describes a low GI crystalline sugar. The preparation of that crystalline sugar was based on the identification of a “sweet spot” in the level of sugar processing (ie the amount the massecuite is washed) where 1. the reducing sugar content is low enough that the sugar is low hygroscopicity and the reducing sugars are not raising the GI of the sucrose and 2. the polyphenol content remains high enough to lower the GI of the sucrose. More specifically, the low GI crystalline sugar included about 0 to 0.5 g/100 g reducing sugars and about 20 mg CE/100 g to about 45 mg CE/100 g polyphenols (or about 16 mg GAE/100 g to about 37 mg GAE/100 g polyphenols) and the sugar particles have a glucose based glycaemic index of less than 55 (ie low glycaemic). Optionally, a first proportion of the polyphenols are entrained within the sucrose crystals and a second proportion of the polyphenols is distributed on the surfaces of the sucrose crystals and/or the polyphenols in the sugar are endogenous and have never been separated from the sucrose crystals.

The sugar particles of the low GI crystalline sugar can be produced from massecuite (which inherently includes polyphenols). An amount of the polyphenols in the massecuite can be removed during processing of the massecuite; and the first proportion and second proportion of the polyphenols remain in the sugar particles after processing of the massecuite. In particular, the amount of the polyphenols in the massecuite removed during processing of the massecuite are removed because the massecuite was washed and the second proportion of polyphenols remain on the surface of the sucrose crystals because washing of the massecuite was ceased before removal of all of the polyphenols from the surfaces of the sucrose crystals. Preferably, the first proportion and second proportion of polyphenols amount to about 20 mg CE/100 g to about 45 mg CE/100 g polyphenols (or about 16 mg GAE/100 g to about 37 mg GAE/100 g polyphenols) and no other polyphenols are present ie in this embodiment no polyphenols are added. Alternatively, the first proportion and second proportion of polyphenols amounts to less than 20 mg CE/100 g to about 45 mg CE/100 g polyphenols and a third portion of polyphenols is added to the sugar particles to reach the desired polyphenol content. Optionally, where a third proportion of polyphenols is added to the sugar particles, that third proportion is less than 50%, 40%, 30%, 20%, 10% of the polyphenol content.

The low GI/GL crystalline sugar can be prepared by washing massecuite to produce sugar particles, wherein the massecuite includes sucrose crystals, polyphenols and reducing sugars, wherein the wash removes an amount of polyphenols and an amount of reducing sugars from the massecuite, wherein the sugar particles comprise about 0 to 0.5 g/100 g reducing sugars and about 20 mg/100 g to about 45 mg/100 g polyphenols and wherein the sugar particles have a glucose based glycaemic index of less than 55 (ie low glycaemic).

In some embodiments, the low glycaemic sugar has higher polyphenol content and comprises at least about 80% w/w sucrose and about 46 mg CE/100 g to about 100 mg CE/100 g or about 37 mg GAE/100 g to about 80 mg GAE/100 g polyphenols. The higher polyphenol content may be achieved by (i) a controlled wash of massecuite as described above, (ii) addition of sugar cane polyphenols to a white sugar, raw sugar, partially processed sugar etc, or (iii) the combination of a controlled massecuite wash and a top up with sugar cane polyphenols and other methods that would be apparent to the skilled person. Sugar cane polyphenols may be extracted from various traditional sugar production waste streams.

In some embodiments, the low glycaemic sugar comprises at least about 80% w/w sucrose, about 46 mg CE/100 g to about 100 mg CE/100 g or about 37 mg GAE/100 g to about 80 mg GAE/100 g polyphenols and 0 to 1.5% w/w reducing sugars, wherein the sugar is not more than 0.5% w/w fructose and not more than 1% w/w glucose.

In some embodiments of the invention the amount of polyphenols in the low GI sugar is about 46 mg CE/100 g to about 100 mg CE/100 g, about 47 mg CE/100 g to about 90 mg CE/100 g, about 48 mg CE/100 g to about 80 mg CE/100 g, about 49 mg CE/100 g to about 70 mg CE/100 g or about 50 mg CE/100 g to about 65 mg CE/100 g. In preferred embodiments of the invention, the polyphenol content in the low GI sugar is about 50 mg CE/100 g to about 65 mg CE/100 g of the sugar. In preferred embodiments, the polyphenol content is about 60 mg CE/100 g of the sugar.

The quantities of polyphenols in the low GI sugars can also be about 37 mg GAE/100 g to about 80 mg GAE/100 g, about 38 mg GAE/100 g to about 70 mg GAE/100 g, about 39 mg GAE/100 g to about 60 mg GAE/100 g, about 40 mg GAE/100 g to about 55 mg GAE/100 g or about 45 mg GAE/100 g to about 55 mg CE/100 g. In preferred embodiments, the polyphenol content is about 45 mg GAE/100 g to about 55 mg GAE /100 g. In preferred embodiments, the polyphenol content is about 50 mg GAE/100 g of the sugar.

In some embodiments, the composition may include about 20 mg CE/100 g to about 100 mg CE/100 g polyphenols (or about 16 mg GAE/100 g to about 80 mg GAE/100 g polyphenols), about 25 mg CE/100 g to about 90 mg CE/100 g polyphenols (or about 20 mg GAE/100 g to about 70 mg GAE/100 g polyphenols), about 30 mg CE/100 g to about 80 mg CE/100 g polyphenols (or about 25 mg GAE/100 g to about 60 mg GAE/100 g polyphenols).

In some embodiments, the low GI sugar is very low glycaemic (for example, having a GI of 10 to 20). A very low glycaemic sugar and various low glycaemic sugars are described in Singapore patent application number SG 10201807121Q. The amorphous sugars described below are also optionally very low glycaemic.

In some embodiments, the sugar particles of the low GI/GL crystalline sugar are about 98 to about 99.5% w/w, about 98.5 to about 99.5% w/w or about 98.8 to about 99.2% w/w sucrose and/or have moisture content of 0.02% to 0.6%, 0.02 to 0.3% 0.02% to 0.2%, 0.1% to 0.5%, 0.1% to 0.4%, 0.1 to 0.2%, 0.2% to 0.3% or 0.3 to 0.4% w/w.

### Amorphous Sugars

In some embodiments, the high intensity sweeteners are combined with or comprised within an amorphous sugar. The amorphous sugar optionally includes polyphenols and caramels sourced from sugar cane.

An amorphous sugar is described in Singaporean patent application number SG 10201800837U, and further amorphous sugars in international patent application number PCT/SG2019/050057. Further amorphous sugars are also described in Singaporean patent application number SG 10201902102Q. The amorphous sugars can contain higher polyphenol content than the low GI crystalline sugars due to the use of a different sugar source (ie cane juice or molasses rather than the crystallised sugar and massecuite that remain after molasses is removed) ie up to 1 g polyphenols CE/100 g carbohydrate. The amorphous sugar comprises sucrose, at least about 20 mg CE polyphenols/100 g carbohydrate, a low GI drying agent (or density lowering agent) and optionally further comprises reducing sugars such as fructose and/or glucose. The amorphous sugar of the invention can be prepared by rapid drying, such as spray drying, a liquid containing sucrose and polyphenols, such as sugar juice or molasses or a combination thereof. The drying agent increases the overall glass transition temperature, allowing cane juice, molasses or a combination of the two to be dried without becoming sticky or caking. A density lowering agent lowers the density of the amorphous sugar when compared to sucrose alone.

The drying agent is optionally a low GI carbohydrate such as corn starch and/or a protein. Alternatively, the edible drying agent is a protein, low GI carbohydrate, lipid and/or natural intense sweetener. Where the drying agent is of limited solubility a solubiliser can be used. Suitable proteins include whey protein isolate, preferably bovine whey protein isolate, β-lactoglobulin, α-lactalbumin, serum albumin, pea protein, sunflower protein and hemp protein. A suitable protein is whey protein isolate, preferably bovine whey protein isolate. Optionally, the low GI drying agent is lactose. Preferably, the low GI drying agent is digestion resistant. Suitable resistant drying agents include hi-maize, fructo-oligosaccharide or inulin, digestive resistant dextrin derivatives or digestive resistant maltodextrin (ie a derivative of maltodextrin that resists digestion in the small intestine of healthy individuals, for example, because at least some of the glucose substituents have been converted to non-digestible forms). Preferred drying agents include a digestive resistant carbohydrate or a digestive resistant starch such as hi-Maize or the protein whey protein isolate or a combination thereof.

In one embodiment, the drying agent is a protein and a low GI carbohydrate combination, for example, whey protein isolate and hi-maize. A 1:1 w/w ratio of whey protein isolate and hi-maize is suitable.

Preferably, the molecular weight of the drying agent is higher than that of the reducing sugars glucose and fructose (ie about 180 g/mol). Optionally, the molecular weight of the drying agent is 200 g/mol to 70 kDa, 300 g/mol to 70 kDa, 500 g/mol to 70 kDa, 800 g/mol to 70 kDa, or 1 kDa to 70 kDa. Optionally, the drying agent has 0 to 0.2% hygroscopicity at 50% relative humidity.

Optionally, the drying agent is 5 to 40% w/w of the sugar.

In some embodiments, the amorphous sugar is a low density amorphous sugar comprising one or more sugars or alternative sweeteners, and an edible density lowering agent.

It is preferred for the amorphous sugar to comprise homogenous particles where each particle comprises both the density lowering agent (or drying agent) and the one or more sugar/alternative sugar. Optionally, the sugar particles are between 1 and 100 μm in diameter (eg a D90 of 100 μm or less). The particles are optionally between 5 and 80 μm, 5 and 60 μm and 5 and 40 μm.

The bulk density of the amorphous sugar is optionally less than 0.8 g/cm³, less than 0.6 g/cm³, less than 0.5 g/cm³.

In some embodiments, the amorphous sugar is a low density amorphous sweetener comprising 40% to 95% w/w sucrose, 0% to 4% w/w reducing sugars, at least about 20 mg CE polyphenols/100 g carbohydrate to about 1 g polyphenols CE/100 g carbohydrate and 5% to 60% w/w low GI density lowering agent (or drying agent).

Optionally, the density lowering agent is about 5 to 40% w/w of the amorphous sugar.

The edible density lowering agent is edible and low density. The edible density lowering agent can be a protein, carbohydrate, fibre (soluble or insoluble or a combination) or natural intense sweetener.

The bulk density of the density lowering agent of the invention is optionally about 0.25 to 0.7 g/cm³, about 0.3 to 0.7 g/cm³, 0.4 to 0.6 g/cm³ or 0.45 to 0.55 g/cm³. Alternatively, the bulk density of the density lowering agent is less than 0.8 g/cm³, less than 0.6 g/cm³, less than 0.5 g/cm³.

Optionally, the density lowering agent is either soluble or powdered version of silicon dioxide, cellulose gum, banana flakes, barley flour, beets, brown rice flour, brown rice protein isolate, brown whey powder, cake flour, calcium carbonate, calcium lactate, calcium silicon, caraway, carrageenan, cinnamon, cocoa beans, cocoa powder, coconut, coffee (dry ground), coffee (flaked), corn meal powder, corn starch, crisped rice, crushed malted barley, crushed soy beans, dehydrated banana flakes, dehydrated potatoes, dehydrated vegetables, dehydrated whole black beans, diacalite (diatomaceous earth), dried brewers yeast, dried calcium carbonate, dried carrots, dried celery, dried bell peppers, dried onions, dried whole whey powder, dried yeast, dry milk powder, egg protein, egg white protein, flour, ground almonds, ground cinnamon, ground corn cobb, ground potato flakes, ground silica, hazelnuts, peanuts, almonds, hemp protein, hydroxyethylcellulose, limestone (calcium carbonate), magnesium flakes, magnesium hydroxide powder, malted barley, malted milk powder, microcrystalline cellulose, milk powder, natural vanilla, parsley, peas, pea protein, potassium chloride, potassium sorbate, potato starch, potato starch flake, potato starch powder, powdered brown sugar, powdered soybean lecithin, quick oat, rice crispy treat cereal, rice short grain, rolled corn, rolled oats, sesame, silica, silicate powder, sodium caseinate, sodium silicate, soy bean mill, soya flour, sugar beet pulp, sunflower seeds, sunflower protein, vanilla, vanilla beans, vitreous fibre, wheat bran fibre, wheat germ, whey (protein) powder, white hulled sesame seeds, whole oat, yellow bread crumbs, whey protein isolate, or combinations thereof.

Optionally, the density lowering agent is either soluble or powdered version of Brown Rice Flour, Caffeinated Coffee Grounds, Cake Flour, Cheese Powder, Cheese Powder Blend, Chestnut Extract Powder, Chocolate, Chocolate Pudding Dry Mix, Chocolate Volcano Cake Base, Cinnamon, Coffee (Decaf), Corn Meal, Corn Starch, Dehydrated Potatoes, Dehydrated Soup, Dehydrated Vegetables, Dried Brewers Yeast, Dried Yeast, Dry Milk, Dry Milk Powder (Non-Fat), Flour, Flour (High Gluten), Flour (Pancake Mix), Flour Breading, Flour Mix, Food Grade Starch, Fumed Silica, Ground Almonds, Ground Cinnamon, Ground Coffee, Guar Gum, Gum Premix (Guar Gum, Locust Bean Gum, Kappa Carragenan), Ice Cream Powder (Chocolate), Malt Mix, Malted Milk Powder, Maltitol Nutriose Blend, Marshmallow Mix, Milk Powder, Milk Powder Based Feed, Milk Powder (Whole), Mixed Spices, Mustard Flour, Onion Powder, Pancake Mix, Pepperoni Spice, Potato Flour, Potato Pancake Mix, Potato Starch, Poultry Gravy, Poultry Seasoning, Powdered Candy Ingredients, Powdered Caramel Color, Powdered Dessert, Protein Drink Mix—Whey, Sweetener, Nutrients, Protein Drink Mixes (Vanilla, Chocolate), Protein Mix (French Vanilla), Salt, Salt & Milk Powder Mix, Salt & Vinegar Seasoning Mix, Seaweed Powder, Silica, Silicate Powder, Sodium Benzoate, Sodium Bicarbonate, Sodium Carbonate, Sodium Caseinate, Sodium Citrate (Citric Acid), Soya Flour, Whey (Protein) Powder, Whey Feed Supplement, Whey Powder, Whey Protein or combinations thereof.

Optionally, the density lowering agent is selected from the group consisting of whey protein isolate, cake flour, cinnamon powder, cocoa powder, coconut powder, vanilla powder, pea/soy/oat/egg (including egg white)/celery/rice/sunflower protein powder, wheat germ, sugar beet pulp, bagasse or sugar cane pulp powder.

Optionally, the density lowering agent is selected from the group consisting of cake flour, cinnamon powder, cocoa powder, coconut powder, vanilla powder, pea/soy/oat/egg (including egg white)/celery/rice/sunflower protein powder, wheat germ, sugar beet pulp, bagasse or sugar cane pulp powder.

Optionally, the density lowering agent is selected from the group consisting of whey protein isolate, sunflower protein, pea protein, egg white protein or combinations thereof. Alternatively, the density lowering agent is sunflower protein, pea protein, egg white protein or combinations thereof.

Suitable proteins include whey protein isolate, preferably bovine whey protein isolate, pea protein, sunflower protein, egg white protein, hemp protein and combinations thereof.

Preferably, the low GI density lowering agent is digestion resistant. Suitable digestion resistant density lowering agents include vitreous fibre, wheat bran fibre, wheat germ, sugar beet or sugar cane pulp, bagasse or combinations thereof. The digestive resistant density lowering agent is optionally a glucose polymer of 3 to 17 or 10 to 14 glucose units. The digestive resistant low GI density lowering agent may be a soluble or insoluble fibre or a combination thereof. One option for the digestive resistant low GI density lowering agent with insoluble fibre is bagasse.

In some embodiments, the density lowering agent is a protein and a low GI carbohydrate combination.

In some embodiments, the ratio of sugar source and density lowering agent is 95:5 to 60:40 by solid weight or 95:5 to 70:30, preferably 90:10 to 80:20 by solid weight. At least 5% w/w of the solids is preferred to achieve sufficient density lowering. The density lowering effect achieved by 5% w/w is improved at 10% and marginally improved at 30% (for whey protein isolate). Higher amounts of density lowering agent had little additional density lowering effect. A product can be prepared with more density lowering agent but at higher amounts the density lowering agent and/or density lowering agent alters the taste profile of the sugar too much.

Optionally, the density lowering agent is from 5% to 60% w/w, 10 to 50% w/w or 20 to 50% w/w of the amorphous sugar/sweetener. Optionally, the density lowering agent is 5% to 60%, 5 to 40%, 5 to 35%, or 10 to 40% by weight. In some embodiments the density lowering agent is 5% to less than 40% w/w of the amorphous sweetener.

A density lowering agent optionally has a molecular weight of 200 g/mol to 70 kDa, 300 g/mol to 70 kDa, 500 g/mol to 70 kDa, 800 g/mol to 70 kDa, or 1 kDa to 70 kDa. Optionally, the density lowering agent is 10 kDa to 60 kDa, 10 kDa to 50 kDa, 10 kDa to 40 kDa, or 10 kDa to 30 kDa. Where the sugar is a monosaccharide, a drying agent may be needed to ensure a non-sticky and free flowing powder product. Density lowering agents of these molecular weights are suitable drying agents.

Optionally, the amorphous sugar comprises about 20 mg CE polyphenols/100 g carbohydrate to about 1 g CE polyphenols/100 g carbohydrate (16 mg GAE polyphenols/100 g to 800 mg GAE/100 g), about 20 mg CE polyphenols/100 g carbohydrate to about 800 mg CE polyphenols/100 g carbohydrate (16 mg GAE polyphenols/100 g to 650 mg GAE/100 g), about 20 mg CE polyphenols/100 g carbohydrate to about 500 mg CE polyphenols/100 g carbohydrate (16 mg GAE polyphenols/100 g to 400 mg GAE/100 g), about 30 mg CE polyphenols/100 g carbohydrate to about 200 mg CE polyphenols/100 g carbohydrate (25 mg GAE polyphenols/100 g to 160 mg GAE/100 g), or about 20 mg CE polyphenols/100 g carbohydrate to about 100 mg CE polyphenols/100 g carbohydrate (16 mg GAE polyphenols/100 g to 80 mg GAE/100 g).

Alternatively, the amorphous sugar comprises about 50 mg CE polyphenols/100 g carbohydrate to about 100 mg CE polyphenols/100 g carbohydrate (40 mg GAE polyphenols/100 g to 80 mg GAE/100 g), 50 mg CE polyphenols/100 g carbohydrate to about 80 mg CE polyphenols/100 g carbohydrate (40 mg GAE polyphenols/100 g to 65 mg GAE/100 g), 50 mg CE polyphenols/100 g carbohydrate to about 70 mg CE polyphenols/100 g carbohydrate (40 mg GAE polyphenols/100 g to 60 mg GAE/100 g), 55 mg CE polyphenols/100 g carbohydrate to about 65 mg CE polyphenols/100 g carbohydrate (45 mg GAE polyphenols/100 g to 50 mg GAE/100 g). In some embodiments there is about 60 mg CE polyphenols/100 g carbohydrate (50 mg GAE polyphenols/100 g). Preferably, the polyphenols are polyphenols that naturally occur in sugar cane (although they do not need to be sourced from sugar cane).

The quantity of caramels in these low GI crystalline sugar and the amorphous sugar can be determined using near-infra-red spectroscopy (NIR).

Optionally, the high intensity sweetener can be added to the sugar liquid used to prepare the amorphous sugar and rapidly dried together with that sugar to produce an amorphous sugar already containing the high intensity sweetener.

Optionally, the amorphous sugar has good or excellent flowability. Optionally, the amorphous sugar has 0 to 0.3% w/w moisture content. Optionally, the amorphous sugar has low hygroscopicity eg 0 to 0.2% at 50% relative humidity. Optionally, the amorphous sugar has high solubility eg >95% in water at 25° C.

The amorphous sugar optionally has 40% to 95% w/w, 50% to 90% w/w or 50 to 80% w/w sucrose. The amorphous sugar optionally has <0.3% w/w reducing sugars.

Optionally, the drying agent is from 5% to 60% w/w, 10 to 50% w/w or 20 to 50% w/w of the amorphous sugar.

Optionally, the reducing sugars are 0% to 6% w/w, 0% to 4% w/w, 0.1% to 3.5% w/w, 0% to 3% w/w, 0% to 2.5% w/w, 0.1% to 2% w/w of the amorphous sugar.

### Other Options

Optionally, the composition further includes 0.05 to 4% w/w salt. Sugar cane juice includes about 0.05 to 0.06% w/w sodium so, when the sucrose and caramel are present in the form of an amorphous sugar prepared by rapidly drying cane juice, there will be some salt present.

Optionally, 10 g of the sweetener composition of the invention has a glycaemic load (GL) of 10 or less, or 8 or less, or 5 or less. Calculation of glycaemic load of an amount of a food is explained in the detailed description below.

Optionally, the sweetener composition of the invention has a glucose based GI of 54 or less or 50 or less. Optionally, the amorphous sugar has a glucose based GI of 54 or less and 10 g of the amorphous sugar has a glucose based GL of 10 or less.

In some embodiments of the present invention, the sweetener composition falls within the maximum residue limits for chemicals set out in Schedule 20 of the Australian Food Standards Code in force July 2017. Sugar prepared by the method described in WO 2018/018090 has been demonstrated to meet these requirements. Sweetener compositions of this invention, will meet these requirements if they comprise a sugar prepared by the method described in WO 2018/018090 and a high intensity sweetener with minimal pesticides or herbicides. Optionally, the sugar meets the following pesticide/herbicide levels: less than 5 mg/kg 2,4-dichlorophenoxyacetic acid, less than 0.05 mg/kg paraquat, less than 0.05 mg/kg ametryn, less than 0.1 mg/kg atrazine, less than 0.02 mg/kg diuron, less than 0.1 mg/kg hexazinone, less than 0.02 mg/kg tebuthiuron, less than 0.03 mg/kg glyphosate, a combination of these or all of these.

Alternatively, the sugar comprises the following pesticide/herbicide levels: less than 0.005 mg/kg 2,4-dichlorophenoxyacetic acid, less than 0.01 mg/kg diquat, less than 0.01 mg/kg paraquat, less than 0.01 mg/kg ametryn, less than 0.01 mg/kg atrazine, less than 0.05 mg/kg bromacil, less than 0.01 mg/kg diuron, less than 0.05 mg/kg hexazinone, less than 0.01 mg/kg simazine, less than 0.01 mg/kg tebuthiuron, less than 0.01 mg/kg glyphosate, a combination of these or all of these.

The sweetener composition of the invention is preferably food grade.

Optionally, the sweetener composition has no (or reduced) metallic aftertaste.

Optionally, the sweetener composition has a caramel flavour with no (or reduced) metallic aftertaste.

### Prebiotic Sugars

In some embodiments, the density lowering agent is a low density digestive resistant carbohydrate and/or amorphous sweetener further comprises a prebiotic agent. For these embodiments, it is preferred that the prebiotic amorphous sweetener has a prebiotic effect when consumed. The prebiotic agent is optionally soluble fibre and/or insoluble fibre.

Suitable prebiotic agents include hi-maize, fructo-oligosaccharide or inulin, bagasse, xanthan gum, digestive resistant maltodextrin or its derivatives, a digestive resistant glucose polymer of 3 to 17 or 10 to 14 glucose units.

Methods for testing the prebiotic effect of the prebiotic amorphous sugar are explained in Singaporean patent application SG 10201809224Y, titled “Compositions that reduce sugar bioavailability and/or have prebiotic effect”, a copy of which is incorporated into the body of this specification by reference.

When the density lowering agent is combined with a prebiotic agent such as a digestive resistant carbohydrate, the ratio is optionally 20:1 to 5:1 w/w respectively.

### Intense Sweeteners

The natural intense sweetener density lowering agents are intensely sweetening plant extracts or juices. These can be either liquid or dried. Suitable extracts and juices in liquid and dried forms are commercially available for stevia, monk fruit and blackberry leaf. In view of the monk fruit products prepared by the inventors, stevia and blackberry leaf versions of the sugars/sweeteners of the invention are expected to be successful.

Optionally, the density lowering agent is monk fruit.

In some embodiments, the density lowering agent is one or more natural intense sweeteners selected from the group consisting of stevia, monk fruit, blackberry leaf and their extracts, with the proviso that when the low GI density lowering agent is monk fruit or a monk fruit extract, the sugar/sweetener is not a monk fruit alternative sweetener.

The other features of the density lowering agent such as molecular weight, hygroscopicity and weight percentage are optionally as described above.

In one embodiment, the density lowering agent or drying agent is a natural intense sweetener, the sugar is sucrose and the sucrose is sourced from cane juice, beet juice or molasses. In embodiments, with cane juice or molasses, the sugar source masks the metallic taste of the high intensity sweetener to either improve the taste of the sugar and/or allow an increased amount of high intensity sweetener while retaining palatability. An increased use of high intensity sweetener will allow for a reduced use of sugar in foods and beverages prepared using this embodiment of the invention.

Where the drying agent and/or density lowering agent is an intense sweetener, the amorphous sugar masks the metallic taste of the sweetener.

### Bulking Agents

In one aspect, the sweetener composition of the invention is combined with a bulking agent to prepare a bulked sweetener composition. The bulking agent may be necessary because the small quantity of high intensity sweetener suitable for use in certain recipes is difficult to handle and a bulking agent can make handling the sweetener composition more straightforward.

Optionally, the bulking agent is prebiotic. In preferred embodiments, the bulking agent is a prebiotic fibre. Suitable prebiotic fibres include non-digestible oligosaccharides or oligosaccharide or low digestibility such as xylooligosaccharides, fructooligosaccharides, galactooligosaccharides isomaltooligosaccharides, soybean oligosaccharides; inulin; pectin; beta-glucans; lactulose; hi-maize; sugarcane bagasse; digestive resistant dextrin derivatives or digestive resistant maltodextrin (ie a derivative of maltodextrin that resists digestion in the small intestine of healthy individuals, for example, because at least some of the glucose substituents have been converted to non-digestible forms) or combinations thereof.

Optionally, the prebiotic is an oligosaccharide. Optionally, the prebiotic oligosaccharide has 2-6 degrees of polymerisation.

Xylooligosaccharides are of particular interest as a prebiotic bulking agent for sugars due to their sweet taste.

Sugarcane bagasse is the waste product of sugar manufacturing. It is the waste remaining after extraction of the sugar juice from crushed sugar cane. Generally, sugarcane bagasse comprises 40-45% cellulose, 20-25% lignin and 25-30% hemicelluloses and small amounts of other materials.

### Prebiotic Sweetener Compositions

Prebiotic sweetener compositions can be prepared by using a drying agent and/or density lowering agent that is prebiotic and then blending the amorphous sugar with an intense sweetener. Alternatively, the drying agent and/or density lowering agent used to make the amorphous sugar can be an intense sweetener such as monk fruit and the amorphous sugar can then be blended with a bulking prebiotic. It is also possible to use a combination of prebiotic and intense sweetener as the drying agent and/or density lowering agent used to make the amorphous sugar.

### Stability

The amorphous sweetener of the first aspect of the invention optionally remains a free flowing powder following 6, 12, 18 or 24 months' storage in ambient conditions.

### Foods and Beverages Containing the Sweetener Composition

The sweetener composition of the invention is suitable for use as an ingredient in other foods or beverages. In another aspect, the present invention provides a method of lowering the GR, GI and/or GL of a food comprising using the sweetener composition and/or the bulked sweetener composition of the invention to prepare a food. It will be apparent to the skilled person that where the sweetener composition of the invention contains an amount of sucrose (and other sugars) and an amount of a low GI drying agent, the GI of the amorphous sugar will vary depending on the proportion of sugar to low GI drying agent. The GL will further vary with the amount of sweetener composition consumed.

In another aspect, the present invention provides a food comprising the sweetener composition of the invention and/or the bulked sweetener composition of the invention.

In one aspect, the present invention further provides a food or beverage comprising 0.1 to 10% w/w sugar, 0.01 to 4% w/w high intensity sweetener and 0.01-4% w/w caramel masking agents. Optionally, the % w/w sugar in the food or beverage is 20 to 60% less than that required when the food or beverage is sweetened with sugar alone. Optionally, the food or beverage further comprises a bulking agent as described above.

In another aspect, the present invention further provides a food or beverage comprising 0.1 to 10% w/w of the crystalline sugar of the invention or the amorphous sugar of the invention and 0.01 to 4% w/w high intensity sweetener. Optionally, the food or beverage further comprises a bulking agent as described above.

In one aspect, the present invention further provides a method of sweetening a food or beverage comprising substituting 0.1 to 10% w/w sugar, 0.01 to 4% w/w high intensity sweetener and 0.01-4% w/w caramel masking agents for the sugar in the food or beverage recipe, wherein the sugar contains sucrose. Optionally, the % w/w sugar in the food or beverage is 20 to 60% less than that required when the food or beverage is sweetened with sugar alone. Optionally, the food or beverage further comprises a bulking agent as described above.

In another aspect, the present invention further provides a method of sweetening a food or beverage comprising substituting 0.1 to 10% w/w of the crystalline sugar of the invention or the amorphous sugar of the invention and 0.01 to 4% w/w high intensity sweetener for the sugar in the food or beverage recipe, wherein the sugar contains sucrose. Optionally, the food or beverage further comprises a bulking agent as described above.

Optionally, the food or beverage comprises 0.02 to 0.08% w/w of one or more high intensity sweetener and 1 to 7% w/w of the crystalline sugar of the invention or the amorphous sugar of the invention.

Optionally, the food or beverage comprises 0.02 to 0.08% w/w monk fruit extract and/or blackberry leaf extract and 1 to 7% w/w of the crystalline sugar of the invention or the amorphous sugar of the invention.

Optionally, the food or beverage comprises 0.02 to 0.08% w/w of one or more high intensity sweeteners; 3 to 8% w/w sucrose and 0.02 to 0.06% w/w or 0.03 to 0.06% w/w caramel masking agents.

Optionally, the food or beverage comprises 0.02 to 0.08% w/w or 0.03 to 0.06% w/w monk fruit extract and/or blackberry leaf extract; 3 to 8% w/w sucrose and 0.02 to 0.06% w/w or 0.03 to 0.06% w/w caramel masking agents.

Beverages prepared are optionally 3 to 6 Brix with sweetness equivalent to 9-12 Brix in a product sweetened with sucrose alone.

In one embodiment, the present invention provides a cola beverage, an iced tea beverage and/or a cordial beverage comprising 0.1 to 10% w/w sugar, 0.01 to 4% w/w high intensity sweetener and optionally 0.01 to 2% w/w caramel masking agents. The cola beverage may also contain cola flavour, acidulant and carbonated water. The iced tea beverage may also contain black tea (eg as a powder), lemon flavour, acid (eg citric acid) and/or additional flavours (eg sodium citrate for the sour salty flavour). The cordial beverage may also contain flavour (eg blackcurrent), colour (eg purple), acid (eg citric acid) and/or additional flavours (eg sodium citrate). Optionally, the sugar is the low GI crystalline sugar of the invention or the amorphous sugar of the invention. Optionally the high intensity sweetener is 0.02 to 0.06% w/w or 0.03 to 0.06% w/w monk fruit. Optionally, the sugar is the low GI crystalline sugar and/or the amorphous sugar described above and when the sugar is the low GI crystalline sugar and/or the amorphous sugar additional caramels are not required.

There are various alternative aspects of the present invention. Several of these are set out below.

In one aspect, the present invention provides a sweetener composition comprising 0.5 to 15% w/w of one or more high intensity sweeteners and (i) a low glycaemic sugar and/or (ii) an amorphous sugar,

wherein the low glycaemic sugar comprises at least about 80% w/w sucrose and about 16 mg GAE polyphenols/100 g carbohydrates to about 80 mg GAE polyphenols/100 g carbohydrates; and
wherein the amorphous sugar comprises sucrose and a drying agent and/or a density lowering agent.

In another aspect, the present invention provides a sweetener composition comprising 0.5 to 15% w/w of one or more high intensity sweeteners and (i) a low glycaemic sugar and/or (ii) an amorphous sugar,

wherein the low glycaemic sugar comprises at least about 80% w/w sucrose and about 16 mg GAE polyphenols/100 g carbohydrates to about 80 mg GAE polyphenols/100 g carbohydrates; and
wherein the amorphous sugar comprises sucrose, is low glycaemic and is about 5% to about 45% w/w drying agent and/or a density lowering agent.

In another aspect, the present invention provides a sweetener composition comprising 0.5 to 15% w/w of one or more high intensity sweeteners and (i) a low glycaemic sugar and/or (ii) an amorphous sugar,

wherein the low glycaemic sugar comprises at least about 80% w/w sucrose and about 16 mg GAE polyphenols/100 g carbohydrate to about 80 mg GAE polyphenols/100 g carbohydrate and about 0 to 1.5% w/w reducing sugars, wherein the low glycaemic sugar is not more than 0.5% w/w fructose; and
wherein the amorphous sugar comprises sucrose and is about 5% to about 45% w/w drying agent and/or a density lowering agent and about 16 mg GAE polyphenols/100 g carbohydrate to about 800 mg GAE polyphenols/100 g carbohydrate.

In another aspect, the present invention provides a sweetener composition comprising 0.5 to 15% w/w of one or more high intensity sweeteners and (i) a very low glycaemic sugar and/or (ii) a very low glycaemic amorphous sugar,

wherein the low glycaemic sugar comprises at least about 80% w/w sucrose and about 50 mg GAE polyphenols/100 g to about 800 mg GAE/100 g polyphenols; and
wherein the amorphous sugar comprises sucrose, is low glycaemic and is about 5% to about 45% w/w drying agent and/or a density lowering agent.

In another aspect, the present invention provides a sweetener composition comprising 0.5 to 15% w/w of one or more high intensity sweeteners and (i) a low glycaemic sugar and/or (ii) an amorphous sugar,

wherein the low glycaemic sugar comprises at least about 80% w/w sucrose and about 16 mg GAE polyphenols/100 g carbohydrates to about 80 mg GAE polyphenols/100 g carbohydrates; and
wherein the amorphous sugar comprises sucrose, is low glycaemic and is about 5% to about 45% w/w drying agent and/or a density lowering agent; and
wherein the amount of sucrose in the sweetener composition is 20 to 60% w/w less than the amount needed for equivalent sweetening by sucrose alone.

In another aspect, the present invention provides a sweetener composition comprising 0.5 to 15% w/w of one or more high intensity sweeteners and (i) a low glycaemic sugar and/or (ii) an amorphous sugar,

wherein the low glycaemic sugar comprises at least about 80% w/w sucrose and about 16 mg GAE polyphenols/100 g carbohydrates to about 80 mg GAE polyphenols/100 g carbohydrates; and
wherein the amorphous sugar comprises sucrose, is low glycaemic and is about 5% to about 45% w/w drying agent and/or a density lowering agent; and
wherein the one or more high intensity sweeteners have a relative sweetness factor of 50 or more, 100 or more, or 200 or more.

In another aspect, the present invention provides a sweetener composition comprising 0.5 to 15% w/w of one or more high intensity sweeteners and (i) a low glycaemic sugar and/or (ii) an amorphous sugar,

wherein the low glycaemic sugar comprises at least about 80% w/w sucrose and about 16 mg GAE polyphenols/100 g carbohydrates to about 80 mg GAE polyphenols/100 g carbohydrates; and
wherein the amorphous sugar comprises sucrose, is low glycaemic and is about 5% to about 45% w/w drying agent and/or a density lowering agent; and
wherein the one or more high intensity sweetener is a natural high intensity sweetener (such as monk fruit extract, blackberry leaf extract, stevia or a combination thereof).

In one aspect, the sweetener composition comprises about 0.5 to about 6% w/w one or more high intensity sweeteners; about 90 to about 99% w/w of a low GI crystalline sugar including sucrose, about 0 to 0.5 g/100 g reducing sugars and about 20 mg CE/100 g to about 45 mg CE/100 g polyphenols; and about 0.5 to about 5% w/w of one or more caramel masking agents, wherein the sweetener composition has a glucose based glycaemic index of less than 55. Optionally, the caramel masking agents inherent in the low GI crystalline sugar are supplemented with added caramel masking agents.

In one aspect, the sweetener composition comprises about 0.5 to about 6% w/w one or more high intensity sweeteners; about 90 to about 99% w/w of a an amorphous sugar including sucrose, at least about 20 mg CE polyphenols/100 g carbohydrate, a low GI drying agent (or density lowering agent) and optionally further comprises reducing sugars such as fructose and/or glucose; and about 0.5 to about 5% w/w of one or more caramel masking agents, wherein the sweetener composition has a glucose based glycaemic index of less than 55. Optionally, the caramel masking agents inherent in the low GI crystalline sugar are supplemented with added caramel masking agents.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 graphs the results of a study on the effect of polyphenol content on the GI of sucrose in the form of traditional refined white sugar. With no polyphenol content the sugar had the GI of sucrose (68). 15 mg CE/100 g polyphenols/carbohydrate slightly lowered the GI to about 66. 30 mg CE/100 g lowered the GI to the low GI of about 50. Surprisingly an increase to 60 mg CE/100 g polyphenols lowered the GI to less than about 20, which is a dramatic and unexpected drop in GI. Finally, an increase in the polyphenol content to 120 mg CE/100 g resulted in a surprising and steep increase in the GI to above about 68, which is at about or higher than the original GI of the sucrose and unexpectedly indicates that the GI lowering effect of the polyphenols is negligible at that dose.

FIG. 2 charts the results of a study on the effect of polyphenol content or polyphenol plus reducing sugar content on the GI of sucrose in the form of traditional refined white sugar. 30, 60 and 120 mg CE/100 g polyphenol content was tested and the results similar to those in FIG. 1. However, the GI for 60 mg CE/100 g was shown to be about 15. Adding 0.6% w/w reducing sugars (1:1 glucose to fructose) to the 30 mg CE/100 g polyphenols and sucrose sugar raised the GI from 53 to 70. Adding 0.6% w/w reducing sugars (1:1 glucose to fructose) to the 60 mg CE/100 g polyphenols and sucrose raised the GI from 15 to 29. Adding 1.2% w/w reducing sugars (1:1 glucose to fructose) to the 120 mg CE/100 g polyphenols and sucrose increased the GI from 65 to 75. The presence of reducing sugar consistently increased the GI.

FIG. 3 graphs the GI of several samples from Table 9 in Example 8.

FIG. 4 graphs the results of an in vitro Glycemic Index Speed Test (GIST) on the 90:10 CJ:WPI amorphous sugar from Example 9 showing the sugar is low glycaemic.

FIG. 5 depicts the sensory profile of the 90:10, 80:20 and 70:30 CJ:WPI % solids amorphous sugars from Example 10. The 90:10 and 80:20 sugars are sweeter than refined white sugar, while the 70:30 is equivalently sweet. The 90:10 and 80:20 sugars have a caramel taste. The 80:20 and 70:30 sugars have a milky taste.

FIGS. 6A-F compare the sensory profile of white refined sugar with various aerated amorphous sweeteners, as follows: A) entry 4 of Table 14 (Example 13) (comprising 80% sugar cane juice, 20% whey protein); B) comprising 80% sugar cane juice, 20% sunflower protein; C) comprising 80% sugar cane juice, 20% monk fruit; D) comprising 90% sugar cane juice, 10% insoluble fibre (bagasse); E) comprising 90% sugar cane juice, 10% soluble fibre; and F) comprising low glycemic raw sugar (30 mg CE polyphenols/100 g). A, C and F are sweeter than white refined sugar. E is equally sweet. A is mouth watering and has a caramel and milky taste. B has an off flavour and a caramel taste. C has aroma and is mouth watering. D has a caramel taste. E has a milky and caramel taste. F has aroma and is mouth watering. It also has a caramel taste.

### DETAILED DESCRIPTION OF THE EMBODIMENTS

Reference will now be made in detail to certain embodiments of the invention. While the invention will be described in conjunction with the embodiments, it will be understood that the intention is not to limit the invention to those embodiments. On the contrary, the invention is intended to cover all alternatives, modifications, and equivalents, which may be included within the scope of the present invention as defined by the claims.

Further aspects of the present invention and further embodiments of the aspects described in the preceding paragraphs will become apparent from the following description, given by way of example.

All of the patents and publications referred to herein are incorporated by reference in their entirety.

For purposes of interpreting this specification, terms used in the singular will also include the plural and vice versa.

One skilled in the art will recognize many methods and materials similar or equivalent to those described herein, which could be used in the practice of the present invention. The present invention is in no way limited to the methods and materials described.

The inventors of the present invention have developed a sweetener composition comprising sucrose, one or more high intensity sweeteners and one or more caramel compounds. The inclusion of the caramels masks the taste of the high intensity sweetener. This benefit can be used to improve the taste profile of the sweetener composition compared to known high intensity sweeteners and their blends with traditional sugar and/or increase the amount of high intensity sweetener that can be used, thereby allowing for further calorie reduction. The inventors have also developed foods and beverages prepared with a combination of sucrose, one or more high intensity sweeteners and one or more caramel compounds. Both the composition and the food and beverages are preferred to be low GI and/or low GL.

The term “amorphous” refers to a solid that is largely amorphous, that is, largely without crystalline structure. For example, the solid could be 80% or more amorphous, 90% or more amorphous, 95% or more amorphous or about 100% amorphous.

The term “entrain” or “entrained” refers to incorporating or drawing in. In relation to crystal formation the term refers to incorporating something into the crystal structure or drawing something into the crystal structure. More specifically, in the context of the present invention the term refers to incorporating polyphenols within the sucrose crystals.

The term “high intensity sweetener” refers to either a natural or an artificial sweetener that has a higher sweetness than sucrose by weight ie less of the high intensity sweetener than the amount of sucrose is needed to achieve a similar sweetness level. Sucrose has a sweetness of 1 on the sucrose relative sweetness scale. For example, monk fruit extract has a sweetness value of about 150 to 300 times sweeter than sucrose, blackberry leaf extract is about 300 times sweeter than sucrose and stevia is about 200-300 times sweeter than sucrose. Monk fruit extract, blackberry leaf extract and stevia are examples of natural high intensity sweeteners because they are sourced from plants by extraction and/or purification.

The term “stevia” refers to a sweetener prepared from the stevia plant including steviol glycosides such as Steviol, Steviolbioside, Stevioside, Rebaudioside A (RA), Rebaudioside B (RB), Rebaudioside C(RC), Rebaudioside D (RD), Rebaudioside E (RE), Rebaudioside F (RF), Rubusoside and Dulcoside A (DA) or a sweetener comprising the highly purified rebaudioside A extract approved by the FDA and commonly marketed as “stevia”.

The term “sugar” refers to a solid that contains one or more low molecular weight sugars such as sucrose. The solid can be amorphous or crystalline.

The term “high glycaemic” refers to a food with a glucose based GI of 70 or more.

The term “low glycaemic” refers to a food with a glucose based GI of 55 or less.

The term “medium glycaemic” refers to a food with a glucose based GI of 56 to 69.

The term “very low glycaemic” refers to a food with a glucose-based GI of less than half the upper limit of low GI (ie the GI is in the bottom half of the low GI range).

The term “reducing sugar” refers to any sugar that is capable of acting as a reducing agent. Generally, reducing sugars have a free aldehyde or free ketone group. Glucose, galactose, fructose, lactose and maltose are reducing sugars. Sucrose is not a reducing sugar.

The term “prebiotic” refers to a food ingredient that stimulates the growth and/or activity of one or more gastrointestinal bacteria. Prebiotics may be non-digestible foods or foods of low digestibility. A prebiotic can be a fibre but not all fibres are prebiotic. Oligosaccharides with a low degree of polymerisation ie are thought to better stimulate bacteria concentration than oligosaccharides with higher degree of polymerisation.

The term “phytochemical” refers generally to biologically active compounds that occur naturally in plants.

The term “polyphenol” refers to chemical compounds that have more than one phenol group. There are many naturally occurring polyphenols and many are phytochemicals. Flavonoids are a class of polyphenols. Polyphenols including flavonoids naturally occur in sugar cane. In the context of the present invention the polyphenols that naturally occur in sugar cane are most relevant. Polyphenols in food are of interest because of the role they are currently thought to have in prevention of degenerative diseases such as cancer, cardiovascular disease or diabetes.

The polyphenols in the sugars of the invention may be synthetic or isolated from a plant, for example, sugar cane. Preferably, the polyphenols are isolated from sugar cane or a sugar cane derived product, such as a sugar processing waste stream. The polyphenols preferably include flavonoids. Preferably, the polyphenols include tricin, luteolin and/or apigenin. Alternatively, the polyphenols include tricin.

The term “refined white sugar” refers to fully processed food grade white sugar that is essentially sucrose with minimal reducing sugar content and minimal phytochemicals such as polyphenols or flavonoids.

The term “sugar” refers to a solid that contains one or more low molecular weight sugars (monosaccharides) such as glucose or disaccharides such as sucrose etc. In the context of the invention, the sugars referred to are edible sugars used in the production of food. The amorphous sugars of the invention could be spray dried cane juice or molasses but could also be spray dried fruit juice.

The term “cane juice” or “sugar cane juice” refers to the syrup extracted from pressed and/or crushed peeled sugar cane. Ideally sugar cane juice is at least 60 Brix.

The term “beet juice” refers to the liquid exiting a diffuser after the beet roots have been sliced into thin strips called cossetes and passed into a diffuser to extract the sugar content into a water solution.

The term “massecuite” refers to a dense suspension of sugar crystals in the mother liquor of sugar syrup. This is the suspension that remains after concentration of the sugar juice into a syrup by evaporation, crystallisation of the sugar and removal of molasses. The massecuite is the product that is washed in a centrifuge to prepare bulk sugar crystals.

The term “cane juice” or “sugar cane juice” refers to the syrup extracted from pressed and/or crushed peeled sugar cane. Ideally sugar cane juice is at least 60 Brix.

The term “molasses” refers to a viscous by-product of sugar preparation, which is separated from the crystallised sugar. The molasses may be separated from the sugar at several stages of sugar processing.

The term “endogenous” refers to something originating from within an organism. In the context of the present invention, it refers to something originating from within sugar cane, for example, a phytochemical including monophenol or polyphenol and polysaccharide can be endogenous because the compound originated from within the sugar cane.

The terms “efficacious” or “effective amount” refer to an amount that is biologically effective. In this context, one example is an effective amount of polyphenols in the sugar particles to achieve a low GI sugar, ie, a sugar that causes a low increase in blood sugar levels once consumed such that an insulin response is avoided.

The term “hi-maize” or “high amylose maize starch” refers to a resistant starch, ie a high molecular weight carbohydrate starch that resists digestion and behaves more like a fibre. Hi-maize is generally made from high amylose corn. There are 2 main structural components of starch; amylose—a linear polymer of glucose residues bound via α-D-(1,4)-glycosidic linkages and amylopectin—a highly branched molecule comprising α-D-(1,4)-linked glucopyranose units with α-D-(1,6)-glycosidic branch points. Branch points typically occur between chain lengths of 20 to 25 glucose units, and account for approximately 5% of the glycosidic linkages. Normal maize starch typically consists of approximately 25 to 30% amylose and 75 to 80% amylopectin. High amylose maize starch contains 55 to >90% amylose. The structure for amylose is (with an average degree of polymerisation of 500):

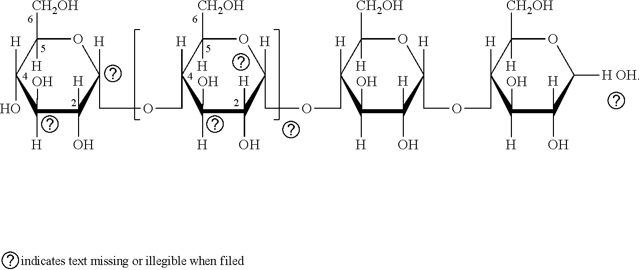

The structure for amylopectin is (with an average degree of polymerisation of 2 million):

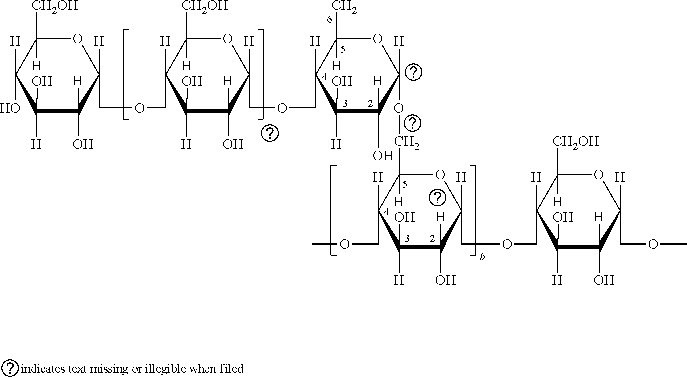

The term “inulin” refers to one or more digestive resistant high molecular weight polysaccharides having terminal glucosyl moieties and a repetitive frucosyl moitey linked by β(2,1) bonds. Generally, inulin has 2 to 60 degrees of polymerisation. The molecular weight varies but can be for example about 400 g/mol, about 522 g/mol, about 3,800 g/mol, about 4,800 g/mol or about 5,500 g/mol. Where there the degree of polymerisation is 10 or less the polysaccharide is sometimes referred to as a fructooligosaccharide. The term inulin has been used for all degrees of polymerisation in this specification. Inulin has the following structure:

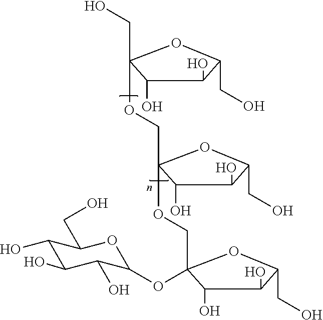

One option is to use Orafti Inulin with a molecular weight of 522.453 g/mol.

The term “dextrin” refers to a dietary fibre that is a D-glucose polymer with α-1,4 or α-1,6 glycosidic bonds. Dextrin can be cyclic ie a cyclodextrin. Examples include amylodextrin and maltodextrin. Maltodextrin is typically a mixture of chains that vary from 3 to 17 glucose units long. The molecular weight can be for example 9,000 to 155,000 g/mol.

The term “digestive resistant dextrin derivatives” refers to a dextrin modified to resist digestion. Examples include polydextrose, resistant glucan and resistant maltodextrin. Fibersol-2 is a commercial product from Archer Daniels Midland Company that is digestion resistant maltodextrin. An example structure is:

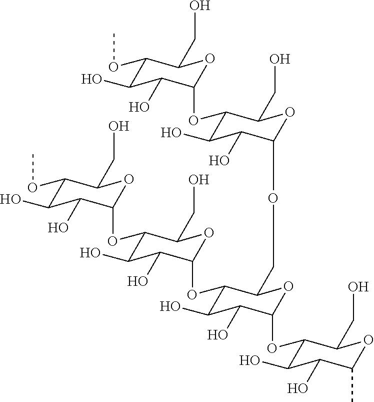

The term “whey protein isolate” refers to proteins isolated from milk, for example, whey can be produced as a by-product during the production of cheese. The whey proteins may be isolated from the whey by ion exchangers or by membrane filtration. Bovine whey protein isolate is a common form of whey protein isolate. Whey protein isolate has four major components: β-lactoglobulin, α-lactalbumin, serum albumin, and immunoglobulins. β-lactoglobulin has a molecular weight of 18.4 kDa. α-lactalbumin has a molecular weight of 14,178 kDa. Serum albumin has a molecular weight of 65 kDa. The immunoglobulin (Ig) in placental mammals are IgA, IgD, IgE, IgG and IgM. A typical immunoglobulin has a molecular weight of 150 kDa.

The term “xylooligosaccharides” refers to sugar oligomers comprised of xylose units joined through β-(1→4)-xylosidic linkages and include xylobiose (2 monomers), xylotriose (3 monomers), xylotetrose (4 monomers), xylopentose (5 monomers) and xylohexose (6 monomers) among others. There are also branched xylooligosaccharides. The xylooligosaccharides can be substituted with acetyl, methyl, phenolic, arabinose, glucuronic acid, uronic acid and arabinofuranosyl among others. Depending on the source, xylooligosaccharides may be possess bound phenolics including ferulic acid and/or coumaric acid, which may provide additional antioxidant and/or immunomodulatory properties.

The term “bagasse” refers to sugar fibre either from sugar cane or sugar beet. It is the fibrous pulp left over after sugar juice is extracted. Bagasse products are commercially available, for example, Phytocel is a sugar cane bagasse product sold by KFSU.

The term “drying agent” refers to an agent that is suitable for rapid drying with sucrose to achieve a dry powder as opposed to the sticky powder achieved is sucrose is dried alone.

The term “high molecular weight drying agent” refers to a drying agent with a molecular weight above that of sucrose, for example, about the molecular weight of lactose or higher.

The term “density lowering agent” refers to an edible product with lower bulk density than bulk white sugar. Preferably, the density is less than 0.7 g/m³. Preferably, the product is soluble or in powder form.

Particle size distribution can be defined using D values. A D90 value describes the diameter where ninety percent of the particle distribution has a smaller particle size and ten percent has a larger particle size.

### Caramel Chemistry

Caramelization is the removal of water from a sugar, proceeding to isomerisation and polymerization into various high-molecular-weight compounds. Compounds such as difructose anhydride may be created from the monosaccharides after water loss. Fragmentation reactions result in low-molecular-weight compounds that may be volatile and may contribute to flavour. Polymerization reactions lead to larger-molecular-weight compounds that contribute to the dark-brown colour.

“Wet caramels” made by heating sucrose and water instead of sucrose alone produce their own invert sugar due to thermal reaction, but not necessarily enough to prevent crystallization in traditional recipes. Raw sugar contains natural caramels and maillard reaction products that are removed during sugar refining. Caramels increase in association with colour (ICUMSA) of raw sugar and can be analysed using a variety of techniques including NIR spectroscopy.

### Monk Fruit Extract and Blackberry Leaf Extract

Monk fruit extract is of interest because it has zero glycaemic index, contains no calories and is a natural product. The sweetness is from the mogrosides which make up about 1% of monk fruit. Monk fruit extract is being cultivated in New Zealand by BioVittoria. Monk fruit extract is also heat stable and has a long shelf life making it suitable for cooking and storage.

Monk fruit extract is prepared by crushing monk fruit and extracting the juice in water. The extract is filtered and the triterpene glycosides called mogrosides collected. It is sold in both liquid and powdered form. The extract is often combined with a bulking agent in powdered form.

Monk fruit extract costs more than stevia but has a less intense metallic after taste than stevia.

The sweetness index for monk fruit extract is up to 300 ie it is up to 300 times sweeter than sucrose depending on the specific extract used.

Blackberry leaf extract is similarly prepared by extracting blackberry leaves. Stevia can be prepared by extracting stevia leaves but it is often further purified to improve the proportion of Rebaudioside A to other components with less beneficial flavour profiles.

Both monk fruit extract and blackberry extract are available from Hunan NutraMax Inc, F25, Jiahege Building, 217 Wanjiali Road, Changsha, China 410016, http://www.nutra-max.com/.

### Polyphenol Content Measurement

Polyphenol content can be measured in terms of its catechin equivalents or in terms of its gallic acid equivalents (GAE). Amounts in mg CE/100 g can be converted to mg GAE/100 g by multiplying by 0.81 ie 60 mg CE/100 g is 49 mg GAE/100 g.

### Glycaemic Response (GR)

GR refers to the changes in blood glucose after consuming a carbohydrate-containing food. Both the GI of a food and the GL of an amount of a food are indicative of the glycaemic response expected when food is consumed.

### GI

The glycaemic index is a system for classifying carbohydrate-containing foods according to how fast they raise blood-glucose levels inside the body. Each carbohydrate containing food has a GI. The amount of food consumed is not relevant to the GI. A higher GI means a food increases blood-glucose levels faster. The GI scale is from 1 to 100. The most commonly used version of the scale is based on glucose. 100 on the glucose GI scale is the increase in blood-glucose levels caused by consuming 50 grams of glucose. High GI products have a GI of 70 or more. Medium GI products have a GI of 55 to 69. Low GI products have a GI of 54 or less. These are foods that cause slow rises in blood-sugar.

Those skilled in the art understand how to conduct GI testing, for example, using internationally recognised GI methodology (see the Joint FAO/WHO Report), which has been validated by results obtained from small experimental studies and large multi-centre research trials (see Wolever et al 2003).

The sugar of the present invention is low glycaemic. In some embodiments, the sugar is very low glycaemic. In particular, the sugar particles of the invention are preferred to have a glucose based glycaemic index of less than 45, optionally less than 30. Optionally, the glucose based glycaemic index is from about 5 to about 45, from about 5 to about 40, from about 5 to about 35, from about 5 to about 30, from about 5 to 25, from about 10 to about 30, from about 10 to about 35 or from about 10 to about 40. In preferred embodiments of the invention, the glucose based glycaemic index of the sugar particles is from about 10 to about 30.

In some embodiments, 10 g of the sugar of the invention has a glycaemic load of 8 or less, 6 or less, 4 or less, 3 or less or 2 or less. Optionally, 10 g of the sugar of the invention has a glycaemic load of 1 to 4.

### GL

Glycaemic load is an estimate of how much an amount of a food will raise a person's blood glucose level after consumption. Whereas glycaemic index is defined for each type of food, glycaemic load is calculated for an amount of a food. Glycaemic load estimates the impact of carbohydrate consumption by accounting for the glycaemic index (estimate of speed of effect on blood glucose) and the amount of carbohydrate that is consumed. High GI foods can be low GL. For instance, watermelon has a high GI, but a typical serving of watermelon does not contain much carbohydrate, so the glycaemic load of eating watermelon is low.

One unit of glycaemic load approximates the effect of consuming one gram of glucose. The GL is calculated by multiplying the grams of available carbohydrate in the food by the food's GI and then dividing by 100. For one serving of a food, a GL greater than 20 is high, a GL of 11-19 is medium, and a GL of 10 or less is low.

### Cane Juice

Cane juice contains all the naturally occurring caramels, macronutrients, micronutrients and phytochemicals normally removed in white refined sugar, which is 99.9% sucrose.

### Molasses

Molasses is s a viscous by-product of sugar preparation, which is separated from the crystallised sugar. The molasses may be separated from the sugar at several stages of sugar processing. Molasses contains the same compounds as cane juice but is a more highly concentrated source of phytochemicals and caramels.

### ICUMSA

ICUMSA is a sugar colour grading system. Lower ICUMSA values represent less colour. ICUMSA is measured at 420 nm by a spectrophotometric instrument such as a Metrohm NIRS XDS spectrometer with a ProFoss analysis system. Currently, sugars considered suitable for human consumption, including refined granulated sugar, crystal sugar, and consumable raw sugar (ie brown sugar), have ICUMSA scores of 45-5,000.

### Taste Profile

It is known that some sweeteners act more on the back of the tongue and some more on the front of the tongue. Without being bound by theory, it is thought that a combination of sweeteners that act on the back and front of the tongue provide a more palatable sweetness profile.

Monk fruit extract acts more on the back of the tongue and blackberry leaf extract acts more on the front of the tongue so the combination of the two is desirable.

High intensity sweeteners may also be combined with other artificial sweeteners to achieve a taste profile that is similar to that of sucrose, for example, xylitol and erythritol.

The sugar particles of the present invention can be prepared to food grade quality by methods known to skilled person including using equipment that has covers to prevent external contamination of the sugar particles, for example by bird droppings, the use of magnets to remove iron shavings and other metals and other methods used to prepare food grade sugar.

### Spray Drying and Other Drying Methods

Spray drying operates on the principle of convection to remove the moisture from the liquid feed, by intimately contacting the product to be dried with a stream of hot air. The spray drying process can be broken down into three key stages: atomisation of feedstock, mixing of spray and air (including evaporation process) and the separation of dried product from the air. Other appropriate drying methods include fluidized bed drying, ring drying, freeze drying and low temperature vacuum dehydration.

### Atomisation

In order to ensure that the particles to be dried have the maximum surface area available to contact the hot air stream, the liquid feed is often atomised, producing very fine droplets ultimately leading to more effective drying. There are several atomiser configurations that exist, the most common being the wheel-type, pneumatic and nozzle atomisers.

A pneumatic high pressure nozzle atomiser was used for the experiments described below.

### Evaporation and Separation

The second stage of the spray drying process involves the evaporation of moisture by using hot gases which flow around the surface of the particles/droplets to be dried.

There are notably three different types of air-droplet contacting configurations that exist: co-current, counter-current and mixed flow, all of which have differing applications depending on the product to be dried.

Both co-current and counter-current drying chambers are able to be used for heat sensitive materials, however the use of mixed-flow drying chambers is restricted to drying materials that are not susceptible to quality degradation due to high temperatures.

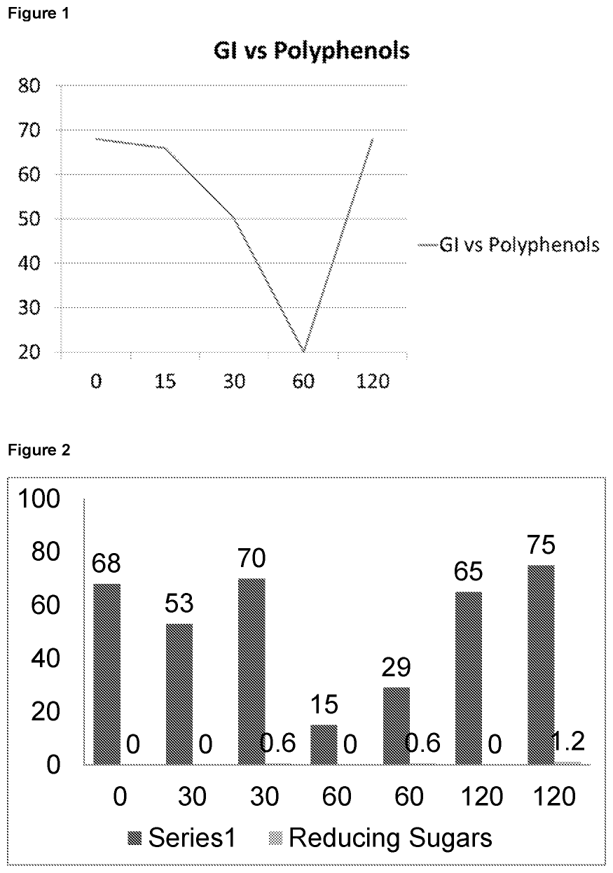

Representations of typical counter-current and co-current dryer setup is shown below in FIG. 1.

The final stage of the spray drying process is the separation of the powder from the air stream. The dry powder collects at the base of the drying chamber before it is discharged or manually collected.

### Glass Transition Temperature

The glass transition temperature (Tg) is the substance-specific temperature range at which a reversible change occurs in amorphous materials from the solid, glassy state to the supercooled liquid state or the reverse. The glass transition temperature becomes very important for the production of dried products, particularly in relation to the processing and storage stages of manufacture. The glass transition temperature of the powders can be determined via differential scanning calorimetry (DSC).

### Prebiotic Testing

The prebiotic effect of the sugars and alternate sweeteners of the invention can be tested using the Triskelion TNO Intestinal Model 2. This in an in vitro model of the gastrointestinal tract including a model colon with a variety of bacterial species presence such that an increase in probiotic following consumption of the prebiotic can be measured.

### Density Testing

Density is preferably testing using a tapped density method. A known mass of powder is added to a graduated cylinder and the cylinder tapped until there is no further volume change. The volume is determined and the density calculated.

### Preparation of a Sweetener Composition of the Invention Comprising a Low or Very Low GI Sugar

A low or very low GI sugar can be prepared from either sugar cane or sugar beet, from refined white sugar or a sugar prepared in accordance with Example 2 (ie a starting sugar). Most starting sugars require the addition of further polyphenols to result in a low or very low GI sugar. Beet sugar does not contain polyphenols and neither does refined white sugar contain more than trace amounts of polyphenols. However, polyphenols can be added to either to prepare a low or very low GI sugar. Sugars prepared by controlled washing of sugar cane massecuite can be prepared with the desired polyphenol content directly but are expected to then contain too much reducing sugar for a low GI and the reducing sugar content will also likely result in a sugar with unacceptable hygroscopicity. For example, if the starting sugar is prepared using the controlled washing method of Example 1 or as described in patent publication numbers WO 2018/018090 and/or WO 2018/018089 to produce a sugar of 20 to 45 mg CE/100 g polyphenols and suitable reducing sugar content, then the sugar still requires additional polyphenols.

The further polyphenols may be added to the sugar in a powdered or liquid form. One option is to spray the liquid or powdered polyphenols onto the sugar. The process for adding the polyphenol additive onto the sugar can be completed as described in Singaporean patent application no SG 10201806479U. Any reducing sugars may be added with or separately to the polyphenols. Alternatively, the reducing sugars may be in the starting sugar.

It is preferred that the polyphenols added to the sugar are polyphenols that, even if not sourced from sugar cane, are present in sugar cane. The polyphenols can be sourced from sugar cane, for example, from a sugar processing waste stream and may be in the form of a sugar cane extract. In some embodiments, the additive is a liquid containing 1000 mg CE/100 g polyphenols and about 11% solids (for example sugars) in water. 0 to 20% sugar is preferred in the additive.

Where the sugar is prepared from sugar cane, the massecuite contains polyphenols. A proportion of the polyphenols in the massecuite are entrained within the sucrose crystals in the massecuite. Massecuite also contains a proportion of polyphenols that are not entrained in the sucrose crystals and the proportion of polyphenols not entrained in the sucrose crystals is generally significantly greater than the proportion of polyphenols entrained within the sucrose crystals. The exact proportions can vary considerably based on variations in the process used to prepare the massecuite and variations in the sugar cane from which the massecuite is prepared. As an example, the quantity of polyphenols not entrained within the sucrose crystals could be tens to hundreds of times more than the amount of polyphenols entrained within the sucrose crystals. Optionally, the polyphenols entrained in the sucrose crystals in the massecuite are retained during processing of the massecuite and remain in the sugar particles. Optionally, an amount of the polyphenols not entrained within the sucrose crystals is retained during processing of the massecuite and remains on the surface of the sugar particles. In other words, a proportion of the polyphenols in the sugar particles can be endogenous to the sugar cane from which the sugar particles are prepared. The endogenous polyphenols may not be separated from and then reintroduced to the sugar particles but remain with the bulk sucrose from which the sugar particles are seeded throughout processing and remain with the sugar particles through the washing process that follows seeding. Alternatively, the polyphenols are retained during processing of the massecuite and remain in the sugar composition because washing of the massecuite was ceased before removal of all of the polyphenols. A consequence of this process is that polyphenols entrained within the sucrose crystals remain within the sucrose crystals from the formation of those crystals and continue to remain within the sucrose crystals within the finished product. Optionally, the polyphenols remain in the sugar particles because washing of the massecuite was ceased before removal of all the polyphenols from the sugar particles (ie washing was ceased before the sugar particles became white). In some embodiments, washing of sugar cane massecuite is ceased when the sugar particles have been washed to contain suitable levels of reducing sugars (ie 0 to 1% w/w). The polyphenol content is then determined and, if needed, additional polyphenols added to achieve the desired about 46 mg CE/100 g to about 100 mg CE/100 g polyphenols.

Alternatively, sugar cane can be refined until there is minimal polyphenol or reducing sugar content and the polyphenol content added to the sugar, for example, by a respraying process.

Alternatively, the sugar can be prepared from beet sugar. In this embodiment, the beet sugar is processed to ensure suitable reducing sugar levels and then suitable polyphenol content added (as polyphenols are not endogenous to beet sugar).

The low or very low GI sugar prepared can then be combined with the high intensity sweetener to produce a sweetener composition according to the invention.

### REFERENCES

International patent application no PCT/AU2017/050782.
International patent application number PCT/SG2019/050057.
Jaffee, W. R., (2012) Sugar Tech, 14:87-94.
Joint FAO/WHO Report. Carbohydrates in Human Nutrition. FAO Food and Nutrition. Paper 66. Rome: FAO, 1998.
Kim, Dae-Ok, et al (2003) Antioxidant capacity of phenolic phytochemicals from various cultivars of plums. Food Chemistry, 81, 321-26.
Singaporean patent application number SG 10201800837U.
Singapore patent application number SG 10201807121Q.
Singaporean patent application number SG 10201902102Q.
Singaporean patent application SG 10201809224Y.
Singaporean patent application no SG 10201806479U.
Wolever T M S et al. (2003) Determination of the glycemic index values of foods: an interlaboratory study. European Journal of Clinical Nutrition, 57:475-482.

A copy of each of these is incorporated into this specification by reference.

### EXAMPLES

### Example 1—Washing of Massecuite to Desired Polyphenol Content

Ten massecuite samples were prepared at two different sugar mills designated “Mill 1” and “Mill 2”. The polyphenol content of each sample was determined (see Example 2). The massecuite samples were washed until they were the depth of colour that is associated with the desired polyphenol content (ie roughly 500 to 2000 ICUMSA) and the polyphenol content measured. The results are in Table 1 below. The skilled person will understand that if the polyphenol content remains too high after the wash, a second wash is possible. The results for each sample are below. The polyphenol content of several of the samples below is too low. Those samples would have to be discarded. It is usual for some sugars prepared at a sugar mill to not meet specifications for various reasons.

TABLE 1
Example sugars

| | | | Polyphenol content |
|---|---|---|---|
| | Massecuite | Less refined sugar | removed during |
| | polyphenols | polyphenols | massecuite washing |
| Sample | (mg CE/100 g) | (mg CE/100 g) | (mg CE/100 g) |
| Mill 1 - 1 | 316.8 | 23.1 | 293.7 |
| Mill 1 - 2 | 312 | 24.3 | 287.7 |
| Mill 1 - 3 | 287.6 | 25.8 | 261.8 |
| Mill 1 - 4 | 291.8 | 18.6 | 273.2 |
| Mill 1 - 5 | 314.6 | 20.5 | 294.1 |
| Mill 1 - 6 | 301.8 | 24.1 | 277.7 |
| Mill 1 - 7 | 277.3 | 17.1 | 260.2 |
| Mill 1 - 8 | 262.3 | 19.5 | 242.8 |
| Mill 1 - 9 | 305.4 | 18.2 | 287.2 |
| Mil1 - 10 | 314.7 | 23.6 | 291.1 |
| Mill 2 - 1 | 283 | 24 | 259 |
| Mill 2 - 2 | 267.2 | 24.2 | 243 |
| Mill 2 - 3 | 246.4 | 24.6 | 221.8 |
| Mill 2 - 4 | 262.2 | 20.2 | 242 |
| Mill 2 - 5 | 270.8 | 30.2 | 240.6 |
| Mill 2 - 6 | 282.6 | 25 | 257.6 |
| Mill 2 - 7 | 269.1 | 23.5 | 245.6 |
| Mill 2 - 8 | 256.8 | 21.2 | 235.6 |
| Mill 2 - 9 | 268.9 | 22.9 | 246 |
| Mill 2 - 10 | 276 | 21.6 | 254.4 |

The sugars with less than the desired polyphenol content can have additional polyphenol content added. A sugar prepared by a controlled wash but having more than 45 mg CE/100 g and a medium to high GI could also be converted to a low GI sugar by the addition of further polyphenols and/or the removal of glucose.

### Example 2—Analysis of Polyphenol Content

40 g of sample was accurately weighed into a 100 ml volumetric flask. Approximately 40 ml of distilled water was added and the flask agitated until the sample was fully dissolved after which the solution was made up to final volume with distilled water. The polyphenol analysis was based on the Folin-Ciocalteu method (Singleton 1965) adapted from the work of Kim et al (2003). In brief, a 50 μL aliquot of appropriately diluted raw sugar solution was added to a test tube followed by 650 μL pf distilled water. A 50 μL aliquot of Folin-Ciocalteu reagent was added to the mixture and shaken. After 5 minutes, 500 μL of 7% Na₂CO₃ solution was added with mixing. The absorbance at 750 nm was recorded after 90 minutes at room temperature. A standard curve was constructed using standard solutions of catechin (0-250 mg/L). Sample results were expressed as milligrams of catechin equivalent (CE) per 100 g raw sample. The absorbance of each sample sugar was determined and the quantity of polyphenols in that sugar determined from the standard curve.

An alternative method for analysis of the polyphenol content is to measure the amount of tricin in a sample using near-infrared spectroscopy (NIR). In these circumstances, the amount of tricin is proportional to the total polyphenols. Further information on this method is available in Australian Provisional Patent Application No 2016902957 filed on 27 Jul. 2016 with the title “Process for sugar production”.

Sugars with 20 to 45 mg polyphenols/100 g carbohydrates and 0 to 0.5 g/100 g reducing sugars are known to have low GI (see PCT/AU2017/050782).

### Example 3—Analysis of the Reducing Sugar Content

There are several qualitative tests that can be used to determine reducing sugar content in a sample. Copper (II) ions in either aqueous sodium citrate or in aqueous sodium tartrate can be reacted with the sample. The reducing sugars convert the copper(II) to copper(I), which forms a copper(I) oxide precipitate that can be quantified.

An alternative is to react 3,5-dinitrosalicylic acid with the sample. The reducing sugars will react with this reagent to form 3-amino-5-nitrosalicylic acid. The quantity of 3-amino-5-nitrosalicylic acid can be measured with spectrophotometry and the results used to quantify the amount of reducing sugar present in the sugar product.

### Example 4—Determining the Amount of Solids Dissolved in Cane Juice or Molasses

A volume of the cane juice or molasses is filtered into a flask via a stocking. A petri dish is weighed and several drops of cane juice are placed on the petri dish and quickly re-weighed to avoid any moisture loss to the surrounding air. The petri dish is then left in an oven containing desiccant pellets at 70° C. overnight and weighed the following day. The sample is re-weighed and left in the oven until a consistent mass is observed. This mass is devoid of moisture and is the total amount of solid from the drops of cane juice. After being weighed, the mass can be calculated against the initial mass to find the mass fraction of total solids in the cane juice for further dilution.

It will be understood that the invention disclosed and defined in this specification extends to all alternative combinations of two or more of the individual features mentioned or evident from the text or drawings. All of these different combinations constitute various alternative aspects of the invention.

### Example 5—Cola Beverages

Standard carbonated soft drinks and fruit juice beverages are sweetened with up to 10% refined sucrose. Monk fruit extract has metallic aftertaste break through at 0.03% w/w or more in a beverage when alone or when combined with white refined sugar.

A standard cola beverage recipe with 10% sugar content was used as a control and alternative recipes prepared replacing the sugar with a low GI/GL sugar prepared according to Example 1 and reducing the sugar content by 50 to 70%. Monk fruit extract high intensity sweetener was added initially as a dose of 0.0036 g for each 1 g of sugar it was replacing. The low calorie cola beverages were taste tested to determine if the monk fruit extract was resulting in a metallic after taste and to assess if the sweetness was similar to the control in intensity and profile.

Monk fruit extract was supplied by Hunan NutraMax Inc, F25, Jiahege Building, 217 Wanjiali Road, Changsha, China 410016, http://www.nutra-max.com/.

TABLE 2
Low calorie cola beverages with monk fruit extract

| | Control | 3% | 3% | 3% | 4% | 4% | 4% | 5% | 5% | 5% |
|---|---|---|---|---|---|---|---|---|---|---|
| | (10%) | (a) | (b) | (c) | (a) | (b) | (c) | (a) | (b) | (b) |
| Cola | 0.16 | 0.16 | 0.16 | 0.16 | 0.16 | 0.16 | 0.16 | 0.16 | 0.16 | 0.16 |
| flavour | | | | | | | | | | |
| Phosphoric | 0.1 | 0.1 | 0.1 | 0.1 | 0.1 | 0.1 | 0.1 | 0.1 | 0.1 | 0.1 |
| Sugar | 10 | 3 | 3 | 3 | 4 | 4 | 4 | 5 | 5 | 5 |
| Example 1 | — | 3 | 3 | 3 | 4 | 4 | 4 | 5 | 5 | 5 |
| sugar | | | | | | | | | | |
| Monk fruit | — | 0.025 | 0.0385 | 0.05 | 0.021 | 0.041 | 0.05 | 0.03 | 0.034 | 0.0375 |
| extract | | | | | | | | | | |
| Water | 19.74 | 26.74 | 26.74 | 26.74 | 26.74 | 26.74 | 26.74 | 26.74 | 26.74 | 26.74 |
| Carbonated | 70 | 70 | 70 | 70 | 70 | 70 | 70 | 70 | 70 | 70 |
| water | | | | | | | | | | |
| Total | 100 | 100 | 100 | 100 | 100 | 100 | 100 | 100 | 100 | 100 |
| Gas volume | 3.5 | 3.5 | 3.5 | 3.5 | 3.5 | 3.5 | 3.5 | 3.5 | 3.5 | 3.5 |
| Brix (° B) | 10.5 | 3.5 | 3.5 | 3.5 | 4.5 | 4.5 | 4.5 | 5.5 | 5.5 | 5.5 |

### Manufacture Process

Samples were prepared by dissolving the sugar and monk fruit extract in water, adding the cola flavour and acid and toping up the mixture with carbonated water.

Samples were tasted after being aged for 2 to 3 days.

### Results

The control was slightly less sweet than a commercial cola, which would have more like 11% sugar.

TABLE 3
Cola beverage taste results

| | Metallic | Sweetness | |
|---|---|---|---|
| Sample | aftertaste | intensity | Sweetness type |
| 3(a) | No | Milder than control | Delayed due to monk fruit |
| | | | extract sweetness profile |
| 3(b) | No | Milder than control | Delayed due to monk fruit |
| | | | extract sweetness profile |
| 3(c) | No | — | Cola flavour changed with |
| | | | monk fruit extract liquorice |
| | | | taste |
| 4(a) | No | Milder than control | Delayed due to monk fruit |
| | | | extract sweetness profile |
| 4(b) | No | Similar sweetness | Slight delayed response |
| | | level to control | due to monk fruit extract |
| | | | sweetness profile |
| 4(c) | No | — | Cola flavour changed with |
| | | | monk fruit extract liquorice |
| | | | taste |
| 5(a) | No | Similar sweetness | Slight delayed response |
| | | level to control | due to monk fruit extract |
| | | | sweetness profile |
| 5(b) | No | Too sweet at the | Cola flavour changed with |
| | | end | monk fruit extract liquorice |
| | | | taste |
| 5(c) | No | Too sweet at the | Cola flavour changed with |
| | | end | monk fruit extract liquorice |
| | | | taste |

Surprisingly no samples suffered from metallic aftertaste, even where 0.05% w/w monk fruit extract was used.

TABLE 4
Low calorie cola beverages with stevia

| | Control | 4% | 5% |
|---|---|---|---|
| | (10%) | (a) | (a) |
| Cola | 0.16 | 0.16 | 0.16 |
| flavour | | | |
| Phosphoric | 0.1 | 0.1 | 0.1 |
| Sugar | 10 | 4 | 5 |
| Low GI | — | 4 | 5 |
| crystalline | | | |
| sugar | | | |
| Stevia | — | 0.2 | 0.1 |
| Water | 19.74 | 26.74 | 26.74 |
| Carbonated | 70 | 70 | 70 |
| water | | | |
| Total | 100 | 100 | 100 |
| Gas volume | 3.5 | 3.5 | 3.5 |
| Brix (° B) | 10.5 | 4.5 | 5.5 |

The manufacturing process is the same as that used for the monk fruit extract containing cola beverages.

TABLE 5
Low calorie cola beverages with monk fruit
extract and blackberry leaf extract/xylitol

| | Control | | |
|---|---|---|---|
| | (10%) | 5% | 5% |
| Cola | 0.16 | 0.16 | 0.16 |
| flavour | | | |
| Phosphoric | 0.1 | 0.1 | 0.1 |
| Sugar | 10 | — | — |
| Example 1 | — | 5 | 5 |
| sugar | | | |
| Blackberry | — | 0.027 | — |
| leaf extract | | | |
| Xylitol | — | — | 2.70 |
| Monk fruit | — | 0.018 | 0.012 |
| extract | | | |
| Water | 19.74 | 24.695 | 22.028 |
| Carbonated | 70 | 70 | 70 |
| water | | | |
| Total | 100 | 100 | 100 |
| Gas volume | 3.5 | 3.5 | 3.5 |
| Brix (° B) | 10.5 | 3.5 | 3.5 |

### Example 6—Iced Tea Beverages

A standard iced tea beverage recipe with 10% refined sugar was used as a control and alternative recipes prepared replacing the sugar with a low GI/GL sugar prepared according to Example 1.

TABLE 6
Low calorie iced tea beverages with blackberry
leaf extract/monk fruit extract

| | Control | |
|---|---|---|
| Ice lemon tea | (10%) | 5% |
| Black Tea | 0.25 | 0.25 |
| Powder | | |
| Lemon | 0.2 | 0.2 |
| Flavour | | |
| Citric Acid | 0.2 | 0.2 |
| Refine Sugar | 10 | — |
| Low GI | — | 5 |
| crystalline | | |
| sugar | | |
| Blackberry | — | 0.044 |
| leaf extract | | |
| Monk fruit | — | 0.035 |
| extract | | |
| Sodium | 0.05 | 0.05 |
| Citrate | | |
| Water | 89.3 | 94.221 |
| Total | 100 | 100 |

### Example 7—Cordial Beverages

A standard cordial beverage recipe with 10% refined sugar was used as a control and alternative recipes prepared replacing the sugar with a low GI/GL sugar prepared according to Example 1.

TABLE 7
Low calorie cordial beverages with blackberry
leaf extract/monk fruit extract

| | Control | |
|---|---|---|
| Blackcurrant cordial | (10%) | 5% |
| Blackcurrant Flavour | 0.15 | 0.15 |
| Refine Sugar | 10 | — |
| Citric Acid | 0.2 | 0.2 |
| Low GI crystalline sugar | — | 5 |
| Blackberry leaf extract | — | 0.035 |
| Monk fruit extract | — | 0.025 |
| Sodium Citrate | 0.03 | 0.03 |
| Purple Colouring | 0.11 | 0.11 |
| Red Noel colouring | 0.0247 | 0.0247 |
| Water | 89.5843 | 94.5243 |
| Total | 100 | 100 |

### Example 8—Effect of Polyphenols on GI of Sugar

The effect of polyphenol content on the GI of sugar was studied. Traditional white sugar ie essentially sucrose was used as a control. Sugars with varied quantities of polyphenols were prepared by adding various amounts of polyphenol content to traditional white sugar.

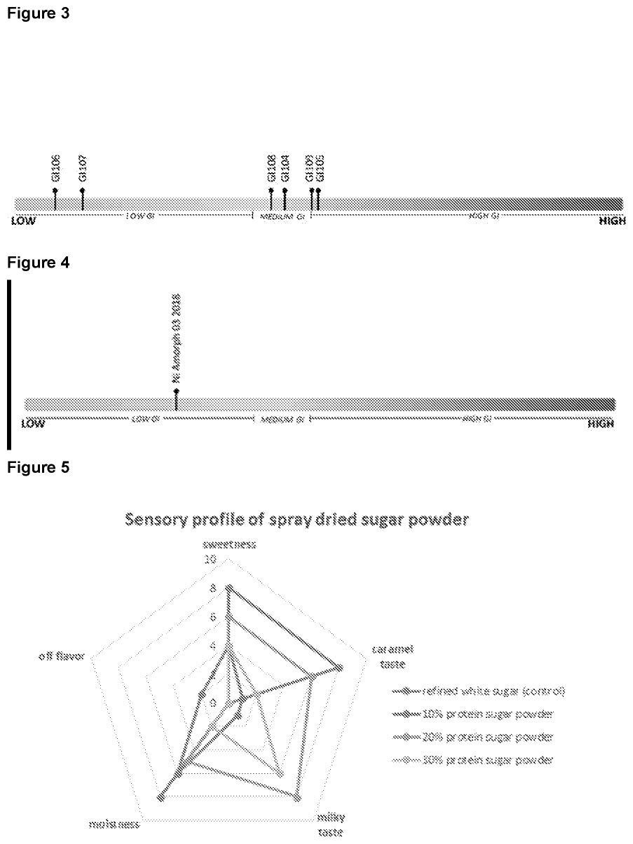

Table 8 shows the results of testing of an in vitro Glycemic Index Speed Test (GIST) on the sugars prepared. The method involved in vitro digestion and analysis using Bruker BBFO 400 MHz NMR Spectroscopy. The testing was conducted by the Singapore Polytechnic Food Innovation & Resource Centre, who have demonstrated a strong correlation between the results of their in vitro method and traditional in vivo GI testing. The results of the GIST testing is also graphed in FIG. 3.

TABLE 8
sugar polyphenol content v GI

| Sample | Polyphenol content | GI number | GI |
|---|---|---|---|
| 1 | 0 mg CE/100 g | About 68 | Medium |
| 2 | 30 mg CE/100 g | <55 (about 53) | Low |
| 3 | 60 mg CE/100 g | <20 (about 15) | Very Low |
| 4 | 120 mg CE/100 g | <68 (about 65) | Medium |

While the GI of fructose is 19, the GI of glucose is 100 out of 100. We therefore expect that the as glucose increases in less refined sugars the glycemic response also concurrently increases.

A second set of sugars were prepared in which reducing sugars (1:1 glucose to fructose) were added to some of the white refined sugar plus polyphenol sugars. The GI of these sugars was also tested using the GIST method and the results are in Table 3.

TABLE 9
Effect of polyphenol and reducing sugar content on Gl

| Sample # | Name of Material/Sample | Sample Code | Gl Banding |
|---|---|---|---|
| 1 | Sugar + 30 mg/ | GI103 | Low |
| | 100 g PP + <0.16% RS | | |
| 2 | Sugar + 30 mg/ | GI104 | Medium |
| | 100 g PP + 0.3% RS | | |
| 3 | Sugar + 30 mg/ | GI105 | Medium/High |
| | 100 g PP + 0.6% RS | | (about 70) |
| 4 | Sugar + 60 mg/ | GI106 | Very low |
| | 100 g PP + 0% RS | | (about 15) |
| 5 | Sugar + 60 mg/ | GI107 | Low (about 29) |
| | 100 g PP + 0.6% RS | | |
| 6 | Sugar + 120 mg/ | GI108 | Med (about |
| | 100 g PP + 0% RS | | 65) |
| 7 | Sugar + 120 mg/ | GI109 | High (about |
| | 100 g PP + 1.2% RS | | 75) |

*PP = polyphenols;
RS = reducing sugars (1:1 glucose:fructose)

The GI of several samples from Table 9 are graphed in FIG. 3.

### Example 9—Low GI Sugars Prepared with Co-Current Spray Drier

### Materials

### Sugar Cane Juice.

Non-Flavoured WPI from Bulk Nutrients

Feed solution mixture for spray drying was 40% w/w. The co-current spray dryer used had capacity to atomize high % feed solutions. A 90:10% cane juice to WPI solids solution was prepared: 1440 g sugar cane juice and 160 g WPI (20% w/w in solid base) were mixed with 2400 g Milli-Q filtered water and stirred well.

### Equipment

Spray dryer in the experiments is fabricated by KODI Machinery co. LTD. Model is LPG-5. Scanning Electron Microscope (SEM) is used to analyse the particle morphology. SEM model is PhenomXL Benchtop. The test sample is coated by Sample Coater (Quorum SC7620 Sputter coaster) prior to analysis.

### Method

The spray drier was set to inlet temperature 170° C. and outlet 62° C. and the feed stock spray dried.

### Results

A free flowing powder is produced with 1% moisture and over 70% yield. The product does not cake and has good stability.

80:20 and 70:30 CJ:WPI % solids sugars were also prepared.

FIG. 4 graphs the results of an in vitro Glycemic Index Speed Test (GIST) on the 90:10 CJ:WPI sugar. The testing involved in vitro digestion of the sugar and analysis using Bruker BBFO 400 MHz NMR Spectroscopy. The testing was conducted by the Singapore Polytechnic Food Innovation & Resource Centre, who have demonstrated a strong correlation between the results of their in vitro method and traditional in vivo GI testing. The 90:10 cane juice to whey protein isolate % solids amorphous sugar is low glycaemic.

As the 90:10 sugar is low GI, the skilled person would expect the higher protein 80:20 and 70:30 sugars to also be low GI. The skilled person would also expect similar results for amorphous sugars with different drying agents, such as fibre, so long as the drying agent has no GI (like protein) or is low GI. Insoluble fibres have little effect on GI so the GI of the amorphous sugar should remain low when an insoluble fibre is the drying agent. Soluble fibres lower the glycaemic index so amorphous sugars having a soluble fibre drying agent will have even lower GI than the tested sugars with a protein drying agent. High intensity sweeteners like stevia or monk fruit sweeteners have a GI of zero. Therefore, amorphous sugars with high intensity sweeteners as a drying agent will also remain low GI.

The polyphenol content of the 90:10 CJ:WPI % solids amorphous sugar was tested for polyphenol content at the Singapore Polytechnic Food Innovation & Resource Centre using the Folin-Ciocalteu assay (UV detection at 760 nm) using an Agilent Cary 60 UV-Vis Spectrophotometer. The sugar has 446.80 mg CE polyphenols/100 g carbohydrates.

### Example 10—Taste Profile for Sugars from Example 9

The 90:10, 80:20 and 70:30 sugars from Example 9 were taste tested by two qualified sensory analysts and two project researchers. The sensory profile is in FIG. 5.

The 90:10 and 80:20 sugars are sweeter than refined white sugar, while the 70:30 is equivalently sweet. The 90:10 and 80:20 sugars have a caramel taste. Without being bound by theory, this taste is thought to be associated with the cane juice. The caramel taste is also thought to result in the taste masking effect. Therefore, these sugars are expected to taste mask at least as well as the sugar of Example 1.

The 80:20 and 70:30 sugars have a milky taste. Without being bound by theory, the milky taste is thought to be associated with the WPI. The presence of the milky taste is not expected to negate the taste masking effect of the caramels, which are still present.

The 80:20 sugar had a good balance of sweet, milky and caramel tastes. The porosity of the particles did not cause a taste issue.

This testing demonstrates how low GI sugars can be prepared with different flavours for different applications.

### Example 11—Composition of Amorphous Sugars

TABLE 10
composition of the 20% WPI:CJ amorphous sugar

| TEST | Result |
|---|---|
| Crude Protein (TP/026) | |
| Protein (N × 6.25) (% of dry matter) | 23.5 |
| Fat by Acid Hydrolysis (TP/050) | |
| Fat (dmb) (% of dry matter) | <1 |
| Saturated Fat (g/100 g) | <0.1 |
| Monounsaturated Fat (g/100 g) | <0.1 |
| Polyunsaturated Fat (g/100 g) | <0.1 |
| Trans Fat (g/100 g) | <0.1 |
| Ash (TP/024) | |
| Ash (dmb) (% of dry matter) | 7.6 |
| Crude Fibre (TP/098) | |
| Crude Fibre (dmb) (% of dry matter) | 1.1 |
| NFE (TP/FT/008) | |
| NFE (%) | 62.5 |
| Metabolisable Energy (Atwater) (TP/FT/008) \hat{ } | |
| ATWATER_ENERGY (kcal/100 g dry matter) | 321 |
| Dry Matter (FT/002) \hat{ } | |
| Dry Matter (%) | 98.3 |
| Moisture (%) | 1.7 |
| Starch (TP/037) \hat{ } | |
| Total Starch (% of dry matter) | 0.9 |
| Sugar Profile (TP/036) | |
| Total Free Sugars (%) | 63 |

TABLE 11
composition of the 20% Sunflower Protein:CJ amorphous sugar

| TEST | Result |
|---|---|
| Crude Protein (TP/026) | |
| Protein (N × 6.25) (% of dry matter) | 19.0 |
| Fat by Acid Hydrolysis (TP/050) | |
| Fat (dmb) (% of dry matter) | <0.2 |
| Ash (TP/024) | |
| Ash (dmb) (% of dry matter) | 2.34 |
| Total Dietary Fibre (TP/025) | |
| Total Dietary Fibre (%) | 3.2 |
| Carbohydrates (Difference) (TP/110) | |
| Carbohydrates (%) | 75.1 |
| Carbohydrates (no TDF) (%) | 78.3 |
| Energy (Human Nutrition) (TP/110) \hat{ } | |
| Energy (calories/100 g dry matter) | 389 |
| Energy kJ/100 g) | 1630 |
| Oven Moisture (TP/022) \hat{ } | |
| Moisture (%) | <1.0 |
| Sugar Profile (TP/036) | |
| Total Free Sugars (%) | 67 |
| Minerals (ICP) | |
| Calcium (mg/kg dry matter) | 1,600 |
| Potassium (mg/kg dry matter) | 5,600 |
| Magnesium (mg/kg dry matter) | 1,000 |
| Phosphorus (mg/kg dry matter) | 990 |
| Sodium (mg/kg dry matter) | 2,700 |
| Sulphur (mg/kg dry matter) | 2,500 |

Crude fibre is the insoluble carbohydrate and NFE (Nitrogen free extract) is the soluble carbohydrate.

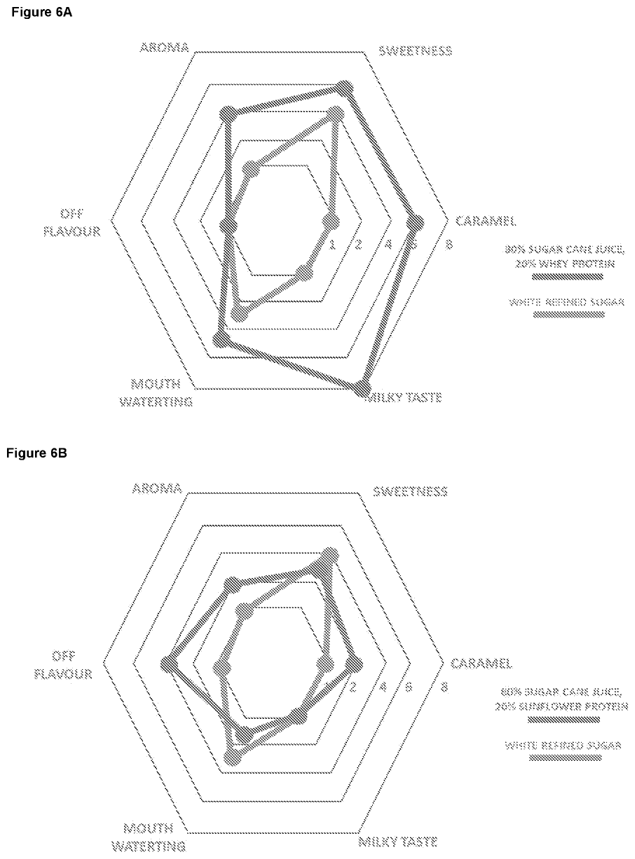

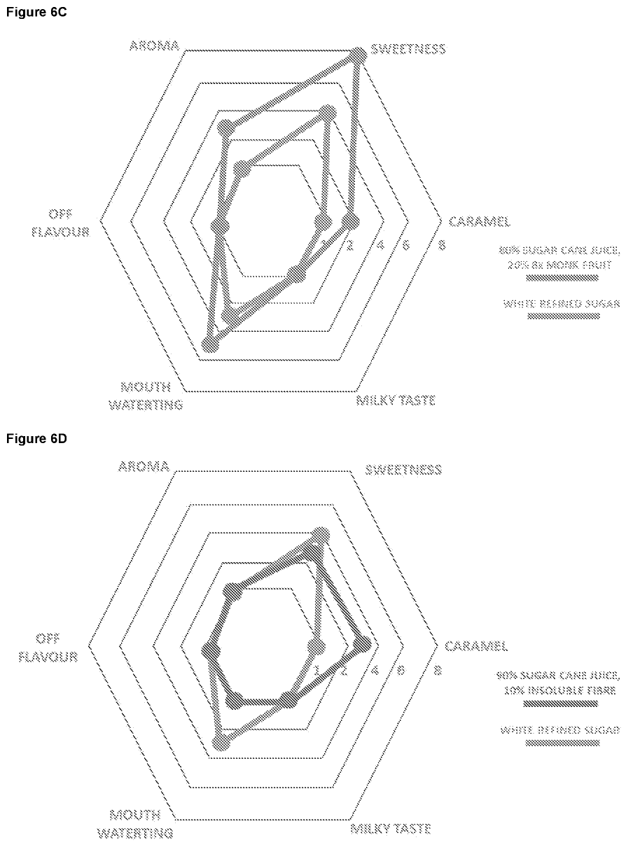

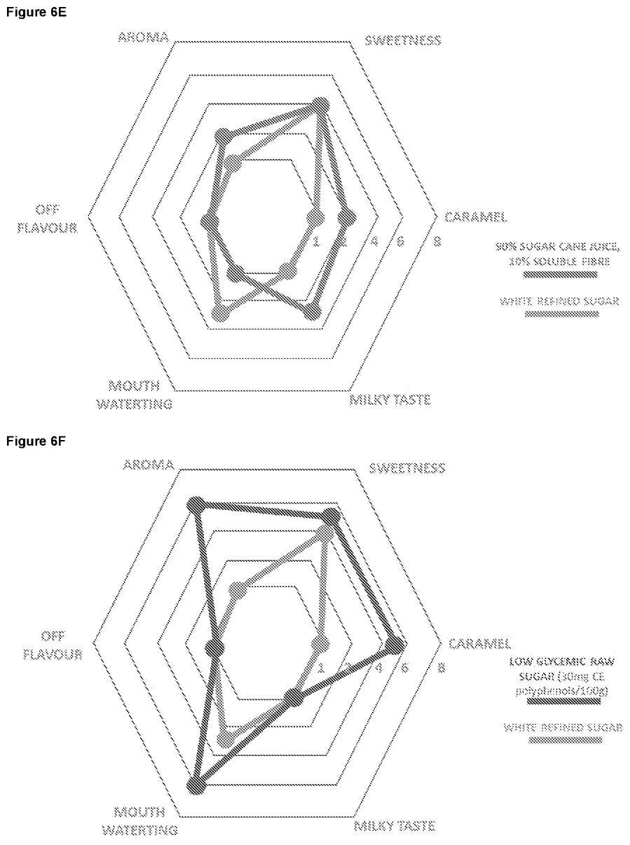

The amorphous sugar of Table 10 has 63% free sugars compared to 100% free sugars for refined white sugar, yet the sweetness of the sugar is comparable (see Example 10 and FIG. 5). This is a 37% reduction in sugar if the amorphous sugar is substituted for white refined sugar in a 1:1 ratio (by weight). However, based on the increased sweetness a substitution of 0.85:1 could be achieved. This would result in a 43% reduction in free sugar. The results for a non-aerated version of the sugar are expected to be identical as this comparison is based on weight not density/volume. The amorphous sugar of Table 11 has 75% free sugars compared to 100% free sugars for refined sugar, yet the sweetness of the sugar is comparable (see Example 13 and FIG. 6B). This is a 25% reduction in sugar if the amorphous sugar is substituted for white refined sugar in a 1:1 ratio (by weight).

Where the sugar source for the amorphous sugar of the invention is sugar cane juice (or something with equivalent composition), the reduction in free sugar is expected to be equivalent independent of the drying agent used (so long as the drying agent does not include free sugar).

White refined sugar is 1,700 kJ/100 g. The amorphous sugar of Table 10 is about 321 cal/100 g, which is about 1343 kJ/100 g. The amorphous sugar of Table 11 is about 389 cal/100 g which is about 1630 kJ/100 g. Therefore, the amorphous sugars of Table 10 and Table 11 contain about 79% and about 96%, respectively, of the total energy/total calories of white refined sugar. In other words, the total energy/total calories by weight of the amorphous sugar is reduced by about 20% and 5%, respectively, when compared to an equivalent weight of white refined sugar. These calculations are based on an aerated sugar and protein blend. The protein included has calories. Non-digestible/digestive resistant foods will have lower to no calories. A sugar with a non-digestible/digestive resistant ingredient instead of a protein will have increased calorie reduction.

The skilled person will understand that the reduction in total energy will vary depending on the nature and amount of the drying agent used. For example, if the drying agent is a fibre, a larger reduction in total energy is expected than where the drying agent is protein. A larger reduction in total energy is expected where a greater amount of drying agent is used, for example, 30% by solid weight.

Traditional white crystalline sugar is about 400 calories per 100 g serve. This 20% solids w/w whey protein isolate and 80% w/w solids sugar cane juice amorphous sugar has 87.5% of the calorie content of an equivalent mass of traditional crystalline white sugar. This is a reduction in calories of 12.5%. The protein in this sugar has calories, if a non-digestible carbohydrate drying agent was used, the calories present would be reduced and the calorie reduction larger. The results will be the same whether or not the sugar is aerated as density is not relevant to this measure.

As mentioned previously, as this amorphous sugar is sweeter than traditional sugar, it is thought that a substitution of 0.85:1 could be achieved. This would result in an about 25.6% reduction in calories by weight.

### Example 12—Amorphous Sugars Prepared with Varied Sugar Sources

In this example, the technology developed to prepare amorphous sugars was applied to prepare amorphous alternative sweeteners with soluble fibre, insoluble fibre or protein including vegan protein.

### Materials

### Recipe 1

### 1) Sweeteners

rice syrup—Pure Harvest: Organic Rice malt syrup
coconut sugar—CSR: unrefined coconut sugar
monk fruit—Morlife: Nature's Sweetener Monk Fruit
maple syrup—Woolworths: 100% pure Canadian Maple syrup
   2) Whey Protein Isolate from BULK NUTRIENTS 100% WPI.

### Feed Solution Mixture

360 g Sweeteners (a. Rice syrup, b. Coconut sugar, c. Monk fruit (300 grams, find the feed solution in the table below) or d. Maple syrup)
40 g WPI
600 g Milli-Q water

### Recipe 2

### 1) Sweetener: Sugar Cane Syrup

### 2) Whey Protein Isolate

3) Soluble fibres (Lotus: Xanthan Gum) or insoluble fibres (KFSU: Phytocel—100% natural sugarcane flour)

### Feed Solution Mixtures

### 3.1) Insoluble Fibres

360 g Sugar Cane Syrup
36 g WPI
4 g Insoluble fibres
600 g Milli-Q water

### 3.2) Soluble Fibres

500 g Sugar Cane Syrup
36 g WPI
4 g Insoluble fibres
400 g Milli-Q water

### Recipe 3

### 1) Sweetener: Sugar Cane Syrup

2) Vegan Protein (Bio Technologies LLC, Sunprotein: Sunflower protein powder).

### Feed Solution Mixture

500 g Sugar Cane Syrup
40 g Vegan Protein
300 g Milli-Q water

### Equipment

1) Spray dryer: LPG5, KODI Machinery co. LTD.

### 2) Scanning Electron Microscope (SEM): Phenom Benchtop SEM: Phenom XL

3) Sample coater: Quorum SC7620 Sputter coater.

### 4) Vacuum Packaging Machine

### Test Procedure

1) Combine and mix the feed solution ingredients to create a stable solution (as opposed to a solution with a stable bubble) before atomization.
2) Spray the solution into the dryer (Inlet 170° C.±1° C., outlet 70° C.±2° C., nozzle size 50 mm).
3) Collect powder from spray dryer. Coat the sample by Quorum SC7620 Sputter coater to prepare them for SEM analysis.
4) SEM analysis.

TABLE 12
Ingredients in the amorphous sugars of Example 12

| | | Sweet- | | Pro- | | | | Water |
|---|---|---|---|---|---|---|---|---|
| | Recipe | ener | g | tein | g | Fibre | g | (g) |
| 1 | 1 | Rice | 360 | WPI | 40 | — | — | 600 |
| | | syrup | | | | | | |
| 2 | 1 | Coconut | 360 | WPI | 40 | — | — | 600 |
| | | sugar | | | | | | |
| 3 | 1 | Monk | 360 | WPI | 40 | — | — | 600 |
| | | fruit | | | | | | |
| 4 | 1 | Maple | 360 | WPI | 40 | — | — | 600 |
| | | syrup | | | | | | |
| 5 | 2 | Sugar | 360 | WPI | 36 | Soluble | 4 | 400 |
| | | Cane | | | | Xanthan | | |
| | | Syrup | | | | Gum | | |
| 6 | 2 | Sugar | 360 | WPI | 36 | Insoluble | 4 | 600 |
| | | Cane | | | | Fibre | | |
| | | Syrup | | | | Bagasse | | |
| | | | | | | (Phytocel) | | |
| 7 | 3 | Sugar | 360 | Sun- | 40 | — | — | 300 |
| | | Cane | | flower | | | | |
| | | Syrup | | pro- | | | | |
| | | | | tein | | | | |

Results

In each case, a free-flowing powder was formed (prior to sputter coating) and aerated amorphous sugar particles were successfully prepared.

The particle size is variable from less than 10 μm to about 60 μm. The aeration/porous nature of the particles is visible in the images of particles that are chipped or incompletely encased.

The bulk density of the powders was determined. The results are in Table 14 below.

TABLE 13
Bulk density results

| | | | | | Density |
|---|---|---|---|---|---|
| | Recipe | Sweetener | Protein | Fibre | g/cm³ |
| 1 | 1 | Rice syrup | WPI (10%) | — | 0.36 |
| 2 | 1 | Coconut | WPI (10%) | — | 0.41 |
| | | sugar | | | |
| 3 | 1 | Monk fruit | WPI (10%) | — | 0.37 |
| 4 | 1 | Maple syrup | WPI | — | 0.41 |
| 5 | 2 | Sugar Cane | WPI (9%) | Soluble | 0.52 |
| | | Syrup | | Xanthan | |
| | | | | Gum (1%) | |
| 6 | 2 | Sugar Cane | WPI (9%) | Insoluble | 0.38 |
| | | Syrup | | Fibre | |
| | | | | Bagasse | |
| | | | | (Phytocel) | |
| | | | | (1%) | |
| 7 | 3 | Sugar Cane | Sunflower | — | 0.55 |
| | | Syrup | protein | | |
| | | | (10%) | | |

The bulk density of the aerated amorphous sugar is about 0.47 g/cm³. These results are similar despite the minimal mixing before spray drying (ie the feed stock was not stirred into a creamy bubble before spray drying). The sunflower protein resulted in aeration but was not quite as effective as the whey protein isolate at 0.55% g/cm³, a 37.5% reduction compared to traditional white sugar.

The rice syrup and monk fruit results were the least dense with a nearly 60% reduction in density. As density is likely to decrease with increasing WPI, a 70% reduction in density is plausible.

### Example 13—Amorphous Sugars Prepared with Varied Density Lowering Agents

In this example, the technology developed to prepare amorphous sugars was applied to prepare amorphous sweeteners with additional substrates or density lowering agents including vegan protein, egg protein and baking powder.

### Materials

### Recipe 1

### 1) Sweeteners

Sugarcane juice
2) Substrates or density lowering agents:
i. Isolated pea protein
ii. Sorghum flour
iii. Egg white powder
iv. WPI

### Feed Solution Mixture

For recipe 1a:
360 g Sugarcane Juice

### 40 g Substrate

600 g Milli-Q water

For recipe 1b:

### 320 g Sugarcane Juice

### 80 g Substrate

600 g Milli-Q water

For recipe 1c:

### 280 g Sugarcane Juice

### 120 g Substrate

600 g Milli-Q water

For recipe 1b* the feed solution was aerated before atomization to create a stable bubble (as described in Example 11). For the other recipes the other powders were only mixed ordinarily to achieve a homogeneous solution to spray dry rather than more vigorously mixed to achieve a stable bubble.

### Recipe 2

### 1) Sweetener: Sugar Cane Syrup

2) Substrates or density lowering agents:
a. Brown Rice Protein
b. Soy Flour

### Feed Solution Mixtures

360 g Sugar Cane Syrup
80 g Substrate
600 g Milli-Q water

The solution was filtered prior to atomization.

### Recipe 3

### 1) Sweetener: Sugar Cane Syrup

### 2) Baking Powder

### Feed Solution Mixture

360 g Sugar Cane Syrup
14 g Baking Powder
300 g Milli-Q water

### Equipment

1) Spray dryer: LPG5, KODI Machinery co. LTD.

### 2) Vacuum Packaging Machine

### Test Procedure

1) Combine and mix the feed solution ingredients to create a stable solution (except for recipe 1b* where a solution with a stable bubble was produced) before atomization.
2) Spray the solution into the dryer (Inlet 170° C.±1° C., outlet 70° C.±2° C., nozzle size 50 mm).
3) Collect powder from spray dryer.

### Results

In each case, a free-flowing powder was formed and aerated amorphous sugar particles were successful prepared. Apart from product 8, the powders were not aerated prior to atomization (as described in example 11). The other powders were only mixed ordinarily to achieve a homogeneous solution to spray dry rather than more vigorously mixed to achieve a stable bubble.

SEM images of products 6-8 from Table 17 are in FIGS. 12A-D (pea protein), FIGS. 13A-D (egg white protein) and FIGS. 14A-G (comprising aeration prior to spray drying). Porosity was observed in these samples. There are no SEM images of products 1-5 and 9-13.

The bulk density of the powders was determined as for the products in Figure x. The results are in Table x below.

TABLE 14
Bulk density results

| | | | | | | Feed | |
|---|---|---|---|---|---|---|---|
| | | Sugar | | | Further | solution | Density |
| | Recipe | source | Protein | Storage | components | preparation | g/cm³ |
| 1 | | — | WPI | — | — | Stirred well | 0.26 |
| 2 | N/A | Refined | — | — | — | N/A | 0.88 |
| | | white | | | | (crystalline | |
| | | sugar | | | | material that | |
| | | | | | | was not | |
| | | | | | | spray dried) | |
| 3 | 1a | Brown | WPI | 1 year | — | Stirred well | 0.43 |
| | | sugar | (10%) | | | | |
| 4 | 1b | Cane | WPI | — | — | Stirred well | 0.44 |
| | | juice | (20%) | | | | |
| 5 | 1c | Cane | WPI | — | — | Stirred well | 0.37 |
| | | juice | (30%) | | | | |
| 6 | 1a | Cane | Egg | — | — | Stirred well | 0.42 |
| | | juice | white | | | | |
| | | | protein | | | | |
| | | | (10%) | | | | |
| 7 | 1a | Cane | Pea | — | — | Stirred well | 0.50 |
| | | juice | protein | | | | |
| | | | isolate | | | | |
| | | | (10%) | | | | |
| 8 | 1b* | Cane | WPI | — | — | Aerated | 0.48 |
| | | juice | (20%) | | | | |
| 9 | | Cane | — | — | Digestive | Stirred well | 0.67 |
| | | juice | | | resistant | | |
| | | | | | maltodextrin | | |
| | | | | | (19%), | | |
| | | | | | lecithin (5%), | | |
| | | | | | fibre (1%) | | |
| 10 | 2 | Cane | — | — | Soy flour, | Stirred well | 0.66 |
| | | juice | | | filtered | | |
| | | | | | (20%) | | |
| 11 | 2 | Cane | — | — | Sorghum, | Stirred well | 0.76 |
| | | juice | | | filtered | | |
| | | | | | (20%) | | |
| 12 | 1b | Cane | Brown | — | — | Stirred well | 0.63 |
| | | juice | rice | | | | |
| | | | protein | | | | |
| | | | isolate | | | | |
| | | | (20%) | | | | |
| 13 | 3 | Cane | — | — | Baking | Stirred well | 0.38 |
| | | juice | | | powder (4%) | | |

The bulk density of the aerated amorphous sugar ranged from 0.37 g/cm³ to 0.66 g/cm³. These results are similar to other substrates used despite the minimal mixing before spray drying (ie the feed stock was not stirred into a creamy bubble before spray drying). The sorghum and brown rice protein resulted in aeration but was not quite as effective as the whey protein isolate at 0.44 g/cm³, but still a significant 27 to 39% reduction compared to traditional white sugar.

Apart from 30% WPI (0.37 g/cm³), the baking powder was the least dense (0.38 g/cm³) with a 63% reduction in density compared to white refined sugar. This was similar to WPI, but only used 4% substrate compared to 30% WPI.

20% WPI when stirred normally or whipped into a bubble before drying had the same bulk density/porosity.

Also, 20% Sunflower Protein (with and without lecithin), 19% Resistant Maltodextrin & 1% soluble/insoluble fibre (with and without lecithin) had similar bulk density, demonstrating that a surfactant does not increase bulk density.

### Example 14—Taste Profiles for Aerated Amorphous Sweeteners

The taste profiles of various aerated amorphous sweeteners were assessed.

A, B and D are sweeter than white refined sugar. F is equally sweet. A has aroma, is mouth watering and has a caramel taste. B has aroma, is mouth watering and has a caramel and milky taste. C has an off flavour. D has an aroma and is mouth watering. E has a caramel taste. F has a milky taste.

The testing demonstrates how different aerated amorphous sweeteners can be prepared with different flavours for different applications. The taste profile of B suggests that this product would be more useful in foodstuffs that cover the flavour of B or in foodstuff where the amount of sugar required is reduced.

TABLE 15
Taste profiles

| | Product ingredients | | | | | | |
|---|---|---|---|---|---|---|---|
| | | | | | | E | F |
| | | | | | | Cane juice | Cane juice |
| | | | | | | with digestive | with digestive |
| | | A | | | | resistant | resistant |
| | | Low glycemic | | C | D | maltodextrin | maltodextrin |
| | | raw sugar (30 mg | B | Cane juice | Cane juice | (19%), insoluble | (19%), soluble |
| | White | CE polyphenols/ | Cane | with sunflower | with monkfruit | fibre (bagasse) | fibre (xanthan |
| Attributes | Sugar | 100 g) | juice | protein (20%) | (10%) | (1%) | gum) (1%) |
| smell | 1 | 6 | 4 | 2 | 3 | 1 | 2 |
| (aroma) | | | | | | | |
| sweetness | 4 | 5 | 6 | 3 | 8 | 3 | 4 |
| caramel | 1 | 5 | 6 | 2 | 2 | 3 | 2 |
| milky taste | 1 | 1 | 8 | 1 | 1 | 1 | 3 |
| mouth | 5 | 6 | 5 | 3 | 5 | 1 | 1 |
| watering | | | | | | | |
| off flavor | 2 | 1 | 1 | 4 | 1 | 1 | 1 |

1. (canceled)

2. (canceled)

3. A sweetener composition comprising
(i) a sugar including sugar cane sourced polyphenols and caramels; and
(iii) one or more high intensity sweeteners.

4. The sweetener composition of claim 3, wherein the sugar is selected from
(a) a low glycaemic sugar comprising about 0 to 0.5 g/100 g reducing sugars and about 20 mg CE/100 g to about 45 mg CE/100 g polyphenols;
(b) a low glycaemic sugar comprising about 80% w/w sucrose and about 37 mg GAE/100 g to about 80 mg GAE/100 g polyphenols;
(c) a very low glycaemic sugar; and/or
(d) an amorphous sugar comprising sucrose, at least about 20 mg CE polyphenols/100 g carbohydrate and an edible low GI drying agent or density lowering agent.

5. The sweetener composition of claim 4, wherein the drying agent and/or density lowering agent has a molecular weight of 200 g/mol to 70 kDa; and/or
the density lowering agent is selected from the group consisting of:
whey protein isolate, cake flour, cinnamon powder, cocoa powder, coconut powder, vanilla powder, pea/soy/oat/egg (including egg white)/celery/rice/sunflower protein powder, wheat germ, sugar beet pulp, bagasse or sugar cane pulp powder.

6. A sweetener composition according to claim 3, wherein the high intensity sweetener is stevia, monk fruit extract or blackberry leaf extract.

7. A sweetener composition according to claim 3, wherein the high intensity sweetener is 0.5 to 11% w/w of the composition.

8. A sweetener composition according to claim 3, wherein the amount of sucrose in the sweetener composition is 20 to 60% w/w less than the amount needed for equivalent sweetening by sucrose alone.

9. A sweetener composition according to claim 3, wherein the one or more high intensity sweeteners have a relative sweetness factor of 50 or more.

10. A bulked sweetener composition comprising the sweetener composition according to claim 3 and a bulking agent.

11. A bulked sweetener composition according to claim 10, wherein the bulking agent is prebiotic.

12. A-bulked sweetener composition according to claim 10, wherein the bulking agent is selected from the group consisting of non-digestible oligosaccharides or oligosaccharides of low digestibility such as xylooligosaccharides, fructooligosaccharides, galactooligosaccharides isomaltooligosaccharides, soybean oligosaccharides; inulin; pectin; beta-glucans; lactulose; hi-maize; sugarcane bagasse; digestive resistant dextrin derivatives or digestive resistant maltodextrin.

13. (canceled)

14. A food or beverage comprising the sweetener composition of claim 3.

15. The food or beverage according to claim 14, wherein the food or beverage comprises 0.02 to 0.06% w/w monk fruit extract and/or blackberry leaf extract and 1 to 7% w/w of (i) a low GI crystalline sugar comprising about 0 to 0.5 g/100 g reducing sugars and about 20 mg CE/100 g to about 45 mg CE/100 g polyphenols and the sugar particles have a glucose based glycaemic index of less than 55; and/or (ii) an amorphous sugar comprising sucrose, at least about 20 mg CE polyphenols/100 g carbohydrate, and a low GI drying agent.

16. (canceled)

17. (canceled)

18. (canceled)

19. (canceled)

20. (canceled)

21. (canceled)

22. (canceled)

23. (canceled)

24. A sweetener composition according to claim 3, wherein the one or more high intensity sweeteners have a relative sweetness factor of 100 or more.

25. A sweetener composition according to claim 3, wherein the one or more high intensity sweeteners have a relative sweetness factor of 200 or more.

26. A sweetener composition according to claim 3, wherein the one or more high intensity sweetener is a natural high intensity sweetener.

27. A sweetener composition according to claim 3, wherein the sweetener composition further comprises an artificial sweetener that is not a high intensity sweetener.

28. A sweetener composition according to claim 4, wherein the sugar is a low glycaemic sugar comprising about 0 to 0.5 g/100 g reducing sugars and about 20 mg CE/100 g to about 45 mg CE/100 g polyphenols and wherein a first proportion of the polyphenols are entrained within the sucrose crystals and a second proportion of the polyphenols is distributed on the surfaces of the sucrose crystals and/or the polyphenols in the sugar are endogenous and have never been separated from the sucrose crystals.

29. A sweetener composition according to claim 3, wherein the polyphenol content in the sugar is about 45 mg GAE/100 g to about 55 mg GAE/100 g of the sugar.

30. A sweetener composition according to claim 3, wherein the sugar is crystalline and about 98 to about 99.5% w/w sucrose.

31. A sweetener composition according to claim 3, wherein the sugar is crystalline and has a moisture content of 0.02% to 0.6% w/w.
